(19) United States
(12) Patent Application Publication
(10) Pub. No.: US 2022/0403167 A1
(43) Pub. Date: Dec. 22, 2022

(54) Composite Fibers Having Aligned Inorganic Nano Structures of High Aspect Ratio and Preparation Method

(71) Applicant: Indian Institute of Technology Delhi, New Delhi (IN)

(72) Inventors: Ashwini Kumar Agrawal, New Delhi (IN); Manjeet Jassal, New Delhi (IN); Ratyakshi Nain, New Delhi (IN); Amol Gorakh Thite, Solapur (IN); Suchismita Bhabani, Chennai (IN); Kiran Yadav, Allahabad (IN)

(73) Assignee: Indian Institute of Technology Delhi, New Delhi (IN)

(21) Appl. No.: 17/843,778

(22) Filed: Jun. 17, 2022

Related U.S. Application Data
(63) Continuation of application No. 15/770,086, filed on Sep. 19, 2018, now abandoned.

(30) Foreign Application Priority Data
Oct. 20, 2015 (IN) 3390/DEL/2015

(51) Int. Cl. C08L 77/02; C08L 23/12; D01F 1/10; D01F 6/06; D01F 6/60; C08K 3/08; C08K 3/22

(52) U.S. Cl. CPC C08L 77/02; C08L 23/12; D01F 1/10; D01F 6/06; D01F 6/60; C08K 3/08; C08K 3/22; Y10T 428/29; B82Y 30/00

(57) ABSTRACT

The disclosure describes composite fibers reinforced with inorganic nanostructures of high aspect ratio with homogeneous dispersion and alignment along the fiber axis and a process for producing said composite fibers. A composite fiber comprising an array of inorganic nanowires embedded in a polymer matrix. The nanowires have a diameter <100 nm and high aspect ratio of at least 5 with homogenous dispersion and polymer chains of the polymer matrix and the nanowires are oriented along the fiber axis. The nanowire wt % in the composite fiber is in the range of 0.01 to 2 wt %. The inorganic nanowires are non conducting and include at least one of ZnO, or aluminosilicate clay tubes.

### RELATED APPLICATIONS

This application claims priority to and is a continuation of U.S. patent application Ser. No. 15/770,086, filed on Sep. 19, 2018, which is a National Stage Entry of PCT/IN2016/050358, filed on Oct. 20, 2016, which claims priority to Indian Application No. 90/DEL/2015, filed on Oct. 20, 2015 the entire contents of which are incorporated herein by reference.

### TECHNICAL FIELD

The present disclosure relates to composite fibers reinforced with inorganic nanostructures of high aspect ratio with homogeneous dispersion and alignment along the fiber axis that are suitable for a variety of applications. The present disclosure also relates to a process for producing composite fibers with inorganic nanostructures of high aspect ratio (referred hereafter as nanowires) with homogeneous dispersion and alignment along the fiber axis.

### BACKGROUND

Carbon nanomaterials are considered as an ideal candidate for reinforcement of polymers because of their unique mechanical properties. The enhancement in the mechanical properties have been achieved using carbon nanotubes (CNTs) reinforced solution spun fibres with different polymers including poly(p-phenylene benzobisoxazole), polyacrylonitrile, polyaniline, and polyvinyl alcohol.

Maximum reported composites are solution based where the dispersion of CNTs is found to be facilitated using solvent. However, the reinforced composites produced at industrial level are likely to be melt processed. The results reported for melt processed composites are not impressive because of the problems associated with dispersion and interfacial shear strength. Moreover, the tensile strength improvement is another concern in CNTs reinforced composite fibers. The effective reinforcement in tensile strength could only be facilitated by dispersion and exfoliation of CNTs in polymer matrices. However, because of the strong van der Waals' forces, CNTs tend to agglomerate and hence resulting in poor dispersion and reinforcement. In addition, CNTs were found to have large amount of impurities and are normally mixture of various diameters, lengths and chirality and other defects. Furthermore, because of their flexible nature, CNTs are normally of twisted and curled morphology and hence the CNT embedded in polymer matrix were not found to be aligned properly when spun as polymer fibers. The aggregation combined with twisted and curled nature dramatically hampers the mechanical properties of the reinforced composites and hence would exhibit only a fraction of their potential. Some selected patents and studies where different nanomaterials have been investigated as fillers in a polymer to obtained composite fibers are as follows:

U.S. 20110224330 describes fiber reinforced composites which were fabricated using a low-temperature, solution-based growth of nanowires, such as ZnO nanowires on the surface of the reinforcing fibers, such as carbon fibers and functionalized aramid fibers.

U.S. Pat. No. 5,770,216 describes electrical conductive polymers including fine particles of zinc oxide which have substantially rod shape of low aspect ratio. The zinc oxide rod-shaped particles confer antistatic properties to particle-containing polymers used in the manufacture of plastics, rubbers, lubricants, adhesives and any other article without affecting the color, appearance, or tactile properties of the resulting product.

U.S. Pat. No. 5,391,432 discloses conductive fibers including a fiber forming component which is manufactured by a process which combines the fiber-forming polymer with zinc oxide rod-shaped particles.

U.S. Pat. No. 5,183,594 describes a composition including zinc oxide whiskers as a conductive filler. Incorporation of a small amount of filler in the composition imparts high electrical conductivity and high plasticity.

U.S. 20080318026 describes a polymer-carbon nanomaterial composite including a polymer matrix and plasma-modified carbon nanomaterials having surface functional groups attached thereof.

U.S. Pat. No. 7,867,468 discloses a method for preparation of reinforcements for composite materials, whereby single- and/or multi-walled carbon nanotubes (CNTs) may be electrophoretically deposited on fibrous substrates for the production of hybrid CNT/fibers. The fibers may include carbon fibers and woven carbon fabrics.

U.S. Pat. No. 6,420,293 discloses ceramic matrix nanocomposite having enhanced mechanical behavior. The aforementioned document also describes a method for producing ceramic articles having improved fracture toughness includes combining of a nanotube filler made up of a nanotube material and a ceramic matrix made up of a nanocrystalline ceramic oxide, forming an article therefrom, and sintering the article under elevated pressure at elevated temperature.

U.S. Pat. No. 7,151,129 describes a fiber-reinforced resin material that uses a single fiber reinforcing ply or a number of fiber reinforcing plies for reinforcing the resin material.

Other than CNTs, nanoclay composite fibers were also reported in nylon, polypropylene and PET fibers even at lower loading values, however mechanical properties of the reinforced composites are not impressive. In most of the above studies reported in the literature, usually higher tensile strength or modulus in composite fibers is achieved at the cost of extensibility (i.e. they have poor extensibility), which gives rise to poor impact strength of the composite fibers. Also, when carbon based nanomaterials are used, the fibers are black in colour and have poor aesthetic appeal for various applications. Therefore, there remains an emerging need for effective composite fibers which is more compatible with the need for affordable and effective application.

### SUMMARY

This summary is provided to introduce concepts related to composite fibers comprising an array of inorganic nanorods and nanowires embedded in a polymer matrix, wherein these nanostructures have a diameter of <100 nm and a high aspect ratio of at least 5 with homogenous dispersion and are oriented along the fiber axis.

The present disclosure provides a process for preparation of a composite fiber comprising an array of inorganic nanostructures embedded in a polymer matrix, wherein the nanowires have diameter of <100 nm and a high aspect ratio of at least 5 with homogenous dispersion and orientation along the fiber axis, the process comprises: contacting nanowires having diameter <100 nm and aspect ratio of at least 5 with a polymer to obtain a mixture comprising nanowires and polymer; subjecting the mixture through melt or solution homogenization to obtain uniform distribution and homogenous dispersion of nanowires in polymer matrix; and subjecting the nanowires in polymer matrix to melt spinning or solution spinning to obtain composite fiber comprising an array of nanowires having diameter <100 nm and aspect ratio of at least 5 oriented along the fiber axis embedded in a polymer matrix.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1A illustrates FE-SEM image of ZnO nanowires of aspect ratio 14.

FIG. 1B illustrates FE-SEM image of the ZnO nanoparticle (aspect ratio 1).

FIG. 1C illustrates FE-SEM image of the ZnO nanowires of aspect ratio 200.

FIG. 2A illustrates XRD pattern of ZnO nanoparticles.

FIG. 2B illustrates XRD pattern of the ZnO nanowires of aspect ratio 14.

FIG. 2C illustrates XRD pattern of the ZnO nanowires of aspect ratio 200.

FIG. 3(i) illustrates thermal behavior (weight %) of ZnO particles reinforced fibers

FIG. 3(ii) illustrates thermal behavior (weight %) of ZnO nanowire (aspect ratio 14) reinforced fibers

FIG. 4(i) illustrates onset temperature of thermal degradation for ZnO/nylon composite fibers with nanoparticles/nanorods/nanowires.

FIG. 4(ii) illustrates temperature of maximum weight loss for ZnO/nylon composite fibers with nanoparticles/nanorods/nanowires.

FIG. 5(i) illustrates thermal behavior (Derivative weight (%/° C.) of ZnO particles reinforced fibers

FIG. 5(ii) illustrates thermal behavior (Derivative weight (%/° C.) of ZnO rods reinforced fibers

FIG. 6 illustrates thermal behavior (weight %) of ZnO wires reinforced fibers.

FIG. 7(i) illustrates thermal behavior (Derivative weight (%/° C.) of ZnO wires reinforced fibers.

FIG. 7(ii) illustrates thermal behavior (weight % magnified view) of ZnO wires reinforced fibers.

FIGS. 8A-F illustrate SEM images of fibers with or without ZnO nanoparticles/nanowires of aspect ratio 14.

FIGS. 9A-D illustrate SEM images of fibers with or without ZnO nanowires of aspect ratio 200.

FIG. 10A-F illustrates SEM images of cross section of composite fibers.

FIGS. 11A-D illustrate SEM images of cross section of composite fibers.

FIG. 12 illustrates the effect of aspect ratio on drawing of composites fibers with different wt % of ZnO nanostructures.

FIG. 13 illustrates the effect of aspect ratio on tensile strength of composites fibers with different wt % of ZnO nanostructures.

FIG. 14 illustrates the effect of aspect ratio on young's modulus of composites fibers with different wt % of ZnO nanostructures.

FIG. 15 illustrates the effect of aspect ratio on tensile stress-strain curves of composite fibers.

FIG. 16 illustrates the effect of aspect ratio on work of rupture of composites fibers with different wt % of ZnO nanostructures.

FIG. 17 illustrates crystallization behavior of composites fibers.

FIG. 18 illustrates Raman spectra of composite fibers in 800-1050 cm⁻¹ range.

FIG. 19 illustrates Raman spectra of composite fibers in 1000-1700 cm⁻¹ range.

FIG. 20 illustrates the effect of aspect ratio on the γ and α % in as spun composite fibers.

FIG. 21 illustrates the effect of aspect ratio on the γ and α content of as-spun/drawn/drawn and heat set composite fibers.

FIG. 22 illustrates the effect of aspect ratio on α/γ ratio of composite fibers.

FIG. 23 illustrates the effect of aspect ratio on melting behavior of composite fibers.

FIG. 24 illustrates the effect of aspect ratio on % crystallinity of composite fibers.

FIG. 25 illustrates the XRD patterns for the composite fibers.

FIG. 26 illustrates the effect of aspect ratio on amorphous and crystalline phases of as-spun fibers.

FIG. 27 illustrates the effect of aspect ratio on amorphous and crystalline phases of composite fibers.

FIG. 28 illustrates the effect of aspect ratio on oriented fraction of amorphous content (Fₒₐ) of composite fibers.

FIG. 29 illustrates the effect of aspect ratio on (a) crystalline orientation factor f_{c} and (b) amorphous orientation factor f_{ab} of composite fibers.

FIG. 30 illustrates best fit of normalized tensile strength vs. volume fraction of ZnO nanostructures in composite fibers using Pukanszky model.

FIG. 31 illustrates SEM image of halloysite nanoclay.

FIG. 32 illustrates wide angle X-ray diffraction (WAXD) spectra of halloysite nanoclay.

FIG. 33 illustrates surface morphology of filaments: a) Nylon 6; b) HNT 0.5/Nylon 6; and c) 1.21 HNT/Si-Nylon 6.

FIG. 34 illustrates WAXD of drawn filaments: a) pure nylon 6; and b) 1.21% HNT/Si-Nylon 6.

FIG. 35 illustrates SAXS spectra of drawn monofilaments: a) Nylon 6; and b) 1.21 HNT/Si-Nylon 6.

FIG. 36 illustrates overlay of melting behavior of filaments: a) nylon 6; b) 0.5 HNT/Nylon 6; c) 0.9 HNT/Nylon 6; and d) 1.21 HNT/Si-Nylon 6.

FIG. 37 illustrates overlay of crystallization behavior of filaments: a) Nylon 6; b) 0.5 HNT/Nylon 6; c) 0.9 HNT/Nylon 6; and d) 1.21 HNT/Si-Nylon 6.

FIG. 38 illustrates tensile stress vs tensile strain curve of filaments a) Nylon 6; b) 0.5 HNT/Nylon 6; c) 0.9 HNT/Nylon 6; and d) 1.21 HNT/Si-Nylon 6.

FIG. 39 illustrates on loading instantaneous extension and creep of filaments: a) Nylon 6; b) 0.5 HNT/Nylon 6; and c) 1.21 HNT/Si-Nylon 6.

FIG. 40 illustrates secondary creep of filaments after unloading: a) Nylon 6; b) 0.5 HNT/Nylon 6; and c) 1.21 HNT/Si-Nylon 6.

FIG. 41 illustrates SEM images of washed ZnO nanowires.

FIG. 42 illustrates thermogram of as spun filament of 0.3 wt % ZnO nanowires master batch.

FIG. 43 illustrates DSC trace of as spun filament of 0.3 wt % ZnO nanowires master batch.

FIG. 44 illustrates Creep behavior of 0.3 wt % FD fibers.

### DETAILED DESCRIPTION OF INVENTION

### Definition of Terms

For convenience, before further description of the present invention, certain terms employed in the specification, examples and appended claims are collected here. These definitions should be read in light of the remainder of the disclosure and understood as by a person of skill in the art. Unless defined otherwise, all technical and scientific terms used herein have the same meaning as commonly understood by a person of ordinary skill in the art.

The articles “a” “an” and “the” are used to refer to one or to more than one (i.e., to at least one) of the grammatical object of the article.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “composite materials” (also called composition materials or shortened to composites) are materials made from two or more constituent materials with significantly different physical or chemical properties, that when combined, produce a material with characteristics different from the individual components. The individual components remain separate and distinct within the finished structure.

Those skilled in the art will be aware that the invention described herein is subject to variations and modifications other than those specifically described. It is to be understood that the invention described herein includes all such variations and modifications. The invention also includes all such steps, features, compositions, and compounds referred to or indicated in the specification, individually or collectively, and any and all combinations of any two or more of said steps or features.

The present disclosure relates to composite fiber comprising an array of inorganic nanowires embedded in a polymer matrix, wherein the nanowires have a diameter of <100 nm and a high aspect ratio of at least 5 with homogenous dispersion and orientation along the fiber axis. In one implementation, the composite fiber includes an array of inorganic nanowires embedded in a polymer matrix, wherein the nanowires have a diameter of <100 nm and a high aspect ratio of at least 10 with homogenous dispersion and orientation along the fiber axis.

In one implementation, the composite fiber comprising an array of inorganic nanowires embedded in a polymer matrix selected from the group consisting of polyesters, polyethylene, polypropylene, poly aromatic amides, polyether ether ketone (PEEK), polybutylene terephthalate (PBT), poly(p-phenylene benzobisoxazole (PBO), polyacrylonitrile, polyamides, polyimide, polyurethanes, conducting polymers, polytetrafluroethane, polyvinylenedifluoride (PVDF), polyimides, cellulose acetate, and combination thereof, wherein the nanowires have a high aspect ratio of at least 5 with homogenous dispersion and orientation along the fiber axis.

In one implementation, the composite fiber comprising an array of inorganic nanowires embedded in a polymer matrix selected from the group consisting of nylon-6, polypropylene, and combination thereof, wherein the nanowires have a high aspect ratio of at least 5 with homogenous dispersion and orientation along the fiber axis. In another implementation, the polymer matrix is of polypropylene.

The polymer matrix can be homo and copolymers of polyesters, such as PET, PBT, PLA, polyethylene, polypropylene, poly aromatic amides, PEEK, PBO, polyacrylonitrile, all kinds of polyamides (6, 66, 11, and the like), polyurethanes, conducting polymers (fiber forming derivatives of polyaniline, polythiophene, polypyrrol), polytetrafluroethane, polyvinylenedifluoride (PVDF), polyimides, cellulose acetate, and the like.

In one implementation, the composite fiber comprising an array of inorganic nanowires embedded in nylon (polymer matrix), wherein the nanowires have a diameter of <100 nm and a high aspect ratio of at least 5 with homogenous dispersion and oriented along the fiber axis.

In one implementation, the composite fiber comprising an array of inorganic nanowires embedded in a polymer matrix, wherein the nanowires are selected from the group of conducting nanowires, non-conducting nanowires, semiconducting nanowires, and combinations thereof and have a diameter of <100 nm and a high aspect ratio of at least 5 with homogenous dispersion and oriented along the fiber axis. In another implementation, the inorganic nanowires are with or without surface modification.

In one implementation, the composite fiber comprising an array of nanowires embedded in a polymer matrix, wherein the nanowires are non-conducting and are selected from the group of ZnO, TiO₂, SiO₂, Al₂O₃, MoOx, aluminosilicate clay tubes, and combinations thereof and have a high aspect ratio of at least 5 with homogenous dispersion and oriented along the fiber axis. In another implementation, the non-conducting nanowires are with or with surface modification.

In one implementation, the composite fiber comprising an array of nanowires embedded in a polymer matrix, wherein the nanowires are non-conducting and are selected from the group of ZnO, aluminosilicate clay tubes, and combinations thereof and have a diameter of <100 nm and a high aspect ratio of at least 5 with homogenous dispersion and oriented along the fiber axis. In another implementation, the composite fiber comprising an array of nanowires embedded in a polymer matrix, wherein the nanowires are non-conducting and are selected from the group of ZnO, aluminosilicate clay tubes, and surface modifications thereof and have a diameter of <100 nm and a high aspect ratio of at least 10 with homogenous dispersion and oriented along the fiber axis.

In one implementation, the composite fiber comprising an array of nanowires embedded in a polymer matrix, wherein the nanowires are conducting and are selected from the group of Ag, Au, Cu, Fe, Ni, Pt, and alloys thereof and have a high aspect ratio of at least 5 with homogenous dispersion and oriented along the fiber axis.

In one implementation, the composite fiber comprising an array of nanowires embedded in a polymer matrix, wherein the nanowires are semiconducting and are selected from the group of Ge, Si, In, In—P, Ga—N, In—Ge, Ge—Ar, and combinations thereof and have a high aspect ratio of at least 5 with homogenous dispersion and oriented along the fiber axis.

In one implementation, the composite fiber comprising an array of nanowires embedded in a polymer matrix, wherein the nanowire is ZnO and has a high aspect ratio of at least 5 with homogenous dispersion and oriented along the fiber axis.

In one implementation, the composite fiber comprising an array of inorganic nanowires embedded in a polymer matrix, wherein the nanowire wt % in the composite fiber is in the range of 0.01 to 50 wt % and has a high aspect ratio of at least 5 with homogenous dispersion and oriented along the fiber axis.

In one implementation, the composite fiber comprising an array of inorganic nanowires embedded in a polymer matrix, wherein the nanowire wt % in the composite fiber is in the range of 0.01 to 10 wt % and has a high aspect ratio of at least 5 with homogenous dispersion and oriented along the fiber axis.

In one implementation, the composite fiber comprising an array of inorganic nanowires embedded in a polymer matrix, wherein the nanowire wt % in the composite fiber is in the range of 0.5 to 2 wt % and has a high aspect ratio of at least 5 with homogenous dispersion and oriented along the fiber axis.

In one implementation, the composite fiber comprising an array of inorganic nanowires embedded in a polymer matrix, wherein the nanowire wt % in the composite fiber is 1.0 wt % and has a high aspect ratio of at least 50 with homogenous dispersion and oriented along the fiber axis.

In one implementation, the composite fiber comprising an array of inorganic nanowires embedded in a polymer matrix selected from the group consisting of polyesters, polyethylene, polypropylene, poly aromatic amides, PEEK, PBT, PBO, polyacrylonitrile, polyamides, polyimide, polyurethanes, conducting polymers, polytetrafluroethane, polyvinylenedifluoride (PVDF), polyimides, cellulose acetate, and combination thereof, wherein the nanowires have high aspect ratio in the range of 10 to 500 (for example diameter of about 50 nm and about length of 7 to 15 μm) with homogenous dispersion and oriented along the fiber axis.

In one implementation, the composite fiber comprising an array of inorganic nanowires embedded in a polymer matrix selected from the group consisting of polyesters, polyethylene, polypropylene, poly aromatic amides, PEEK, PBT, PBO, polyacrylonitrile, polyamides, polyimide, polyurethanes, conducting polymers, polytetrafluroethane, polyvinylenedifluoride (PVDF), polyimides, cellulose acetate, and combination thereof, wherein the inorganic nanowires are selected from the group of conducting nanowires, non-conducting nanowires, semiconducting nanowires, and combinations thereof and have high aspect ratio in the range of 5 to 500 with homogenous dispersion and oriented along the fiber axis.

In one implementation, the composite fiber comprising an array of inorganic nanowires embedded in a polymer matrix selected from the group consisting of polyesters, polyethylene, polypropylene, poly aromatic amides, PEEK, PBT, PBO, polyacrylonitrile, polyamides, polyimide, polyurethanes, conducting polymers, polytetrafluroethane, polyvinylenedifluoride (PVDF), polyimides, cellulose acetate, and combination thereof, wherein the inorganic nanowires are selected from the group of conducting nanowires, non-conducting nanowires, semiconducting nanowires, and combinations thereof and have high aspect ratio in the range of 5 to 500 with homogenous dispersion and oriented along the fiber axis wherein the nanowire wt % in the composite fiber is in the range of 0.01 to 50 wt %.

In one implementation, the composite fiber comprising an array of inorganic nanowires embedded in a polymer matrix selected from the group consisting of polyesters, polyethylene, polypropylene, poly aromatic amides, PEEK, PBT, PBO, polyacrylonitrile, polyamides, polyimide, polyurethanes, conducting polymers, polytetrafluroethane, polyvinylenedifluoride (PVDF), polyimides, cellulose acetate, and combination thereof, wherein the nanowires are non-conducting and are selected from the group of ZnO, TiO₂, SiO₂, Al₂O₃, MoOx, aluminosilicate clay tubes, and combinations thereof and have high aspect ratio in the range of 5 to 500 with homogenous dispersion and oriented along the fiber axis wherein the nanowire wt % in the composite fiber is in the range of 0.01 to 50 wt %.

In one implementation, the composite fiber comprising an array of inorganic nanowires embedded in a polymer matrix selected from the group consisting of nylon-6, polypropylene, and combination thereof, wherein the nanowires are non-conducting and are selected from the group of ZnO, aluminosilicate clay tubes, and combinations thereof and have high aspect ratio in the range of 5 to 500 with homogenous dispersion and oriented along the fiber axis wherein the nanowire wt % in the composite fiber is in the range of 0.01 to 50 wt %.

In one implementation, the composite fiber comprising an array of inorganic nanowires embedded in nylon (polymer matrix), wherein the nanowire is ZnO and have high aspect ratio in the range of 5 to 500 with homogenous dispersion and orientation along the fiber axis, wherein the nanowire wt % in the composite fiber is in the range of 0.01 to 10 wt %.

In one implementation, the composite fiber comprising an array of inorganic nanowires embedded in nylon (polymer matrix), wherein the nanowire is ZnO and have high aspect ratio in the range of 10 to 500 with homogenous dispersion and orientation along the fiber axis, wherein the nanowire wt % in the composite fiber is in the range of 0.5 to 2 wt %.

In one implementation, the composite fiber comprising an array of inorganic nanowires embedded in a polymer matrix, wherein the nanowires have high aspect ratio in the range of 5 to 500 with homogenous dispersion and oriented along the fiber axis.

In one implementation, the composite fiber comprising an array of inorganic nanowires embedded in nylon (polymer matrix), wherein the nanowires have high aspect ratio in the range of 100 to 500 with homogenous dispersion and oriented along the fiber axis.

In one implementation, the composite fiber comprising an array of inorganic nanowires embedded in nylon (polymer matrix), wherein the nanowires wt % in the composite fiber is in the range of 0.01 to 50 wt % and have high aspect ratio in the range of 100 to 500 with homogenous dispersion and oriented along the fiber axis.

In one implementation, the composite fiber comprising an array of nanowires embedded in nylon (polymer matrix), wherein the nanowires wt % in the composite fiber is in the range of 0.01 to 10 wt % and have high aspect ratio in the range of 5 to 500 with homogenous dispersion and oriented along the fiber axis.

In one implementation, the composite fiber comprising an array of nanowires embedded in nylon (polymer matrix), wherein the nanowires wt % in the composite fiber is in the range of 0.5 to 2 wt % and have high aspect ratio in the range of 100 to 500 with homogenous dispersion and oriented along the fiber axis.

In one implementation, the composite fiber comprising an array of nanowires embedded in polypropylene (polymer matrix), wherein the nanowires wt % in the composite fiber is in the range of 0.5 to 2 wt % and have high aspect ratio in the range of 100 to 500 with homogenous dispersion and oriented along the fiber axis.

In one implementation, the composite fiber comprising an array of nanowires embedded in nylon (polymer matrix), wherein the nanowires wt % in the composite fiber is 1.0 wt % and have high aspect ratio in the range of 5 to 300 with homogenous dispersion and oriented along the fiber axis.

The spinning of fibres from nanostructure-polymer blends is a major challenge in the area of composites. The stretching of polymer chains during spinning process can facilitate the alignment of molecular chains along the fiber axis. This further improves the tensile strength of the fibers. Processing of composites in the form of fibers can align the nanostructures along the fiber axis resulting in better mechanical properties.

The efficient reinforcement in polymer composites requires high aspect ratio of nanostructures, homogeneous dispersion and uniform distribution in the polymer matrix, alignment of nanostructures in load direction and interfacial load transfer.

The disclosure relates to spinning of polymeric fibers with high aspect ratio rigid nanowires. As used herein term ‘nanowires’ refers to an inorganic particle having aspect ratio (i.e length/diameter) of at least >5. The preferable diameter is <100 nm and length in μm. The process involves the dispersion and spinning of nanowires/polymer composite. The nanowires were found to be homogeneously dispersed and aligned along the fiber axis. The reinforcement was done at very low loading values of <2 wt % and the tensile strength was improved without significantly affecting the elongation of the fibers resulting in high work of rupture. The rigidity of nanowire was found to facilitate the individualization even in the absence of any solvent.

The present disclosure provides a process for preparation of a composite fiber comprising an array of inorganic nanostructures embedded in a polymer matrix, wherein the nanowires have diameter of <100 nm and a high aspect ratio of at least 5 with homogenous dispersion and orientation along the fiber axis, the process comprises: contacting nanowires having diameter <100 nm and aspect ratio of at least 5 with a polymer to obtain a mixture comprising nanowires and polymer; subjecting the mixture through melt or solution homogenization to obtain uniform distribution and homogenous dispersion of nanowires in polymer matrix; and subjecting the nanowires in polymer matrix to melt spinning or solution spinning to obtain composite fiber comprising an array of nanowires having diameter <100 nm and aspect ratio of at least 5 oriented along the fiber axis embedded in a polymer matrix. The polymer may be in the form of granules or solution form. The inorganic nanowires can be in the form of powder or liquid dispersion. In one implementation, the process for preparation of a composite fiber including an array of nanowires embedded in a polymer matrix, wherein the nanowires have a high aspect ratio of at least 5 with homogenous dispersion and oriented along the fiber axis, the process comprises: contacting nanowires having aspect ratio of at least 5 in a liquid to obtain a dispersion comprising nanowires; contacting the dispersion comprising nanowires with polymer granules to obtain a mixture comprising nanowires and polymer; removing the liquid from the mixture comprising nanowires and polymer to obtain nanowire coated or embedded polymer; subjecting the polymer-nanowire mixture through melt or solution homogenizer such as twin screw extruder or high speed shear stirrer to obtain uniform distribution and homogenous dispersion of nanowires in polymer matrix; subjecting the nanowires in polymer matrix to melt spinning or solution spinning to obtain composite fiber comprising an array of nanowires having aspect ratio of at least 5 oriented along the fiber axis embedded in a polymer matrix.

In one implementation, the polymer is selected from the group consisting of polyesters, polyethylene, polypropylene, poly aromatic amides, PEEK, PBT, PBO, polyacrylonitrile, polyamides, polyimide, polyurethanes, conducting polymers, polytetrafluroethane, polyvinylenedifluoride (PVDF), polyimides, cellulose acetate, and combination thereof. In another implementation, the polymer is nylon.

In one implementation, the liquid is a polar solvent. In another implementation, the liquid is acetone. The liquid can be a polar solvent, a non-polar solvent, or combinations thereof. Examples of liquids include water, methanol, acetone, higher alcohols, ethers, N-methyl-2-pyrolidone (NMP), N,N-dimethyl formamide (DMF), pyridine, pyrrole, carbon tetra chloride, o-dichlorobenzene, isoamyl acetate, 1,4-dichlorobenzene, chloroform, and combinations thereof. In one implementation, the solvent can be acetone, N-methyl-2-pyrolidone (NMP), and N,N-dimethyl formamide (DMF).

The inorganic nanowires can be conducting nanowires, non-conducting nanowires, semiconducting nanowires, or combinations thereof. In one implementation, the inorganic nanowires can be with or without surface modification. In one implementation, the nanowires are non-conducting and are selected from the group of ZnO, TiO₂, SiO₂, Al₂O₃, MoOx, aluminosilicate clay tubes, and combinations thereof. In one implementation, the non-conducting nanowires is ZnO, aluminosilicate clay tubes, and surface modifications thereof. The surface of the nanowires can be chemically and physically modified according to methods known to person skilled in the art. In another implementation, the nanowires are conducting and are selected from the group of Ag, Au, Cu, Fe, Ni, Pt, and alloys thereof. In yet another implementation, the nanowires are semiconducting and are selected from the group of Ge, Si, In, In—P, Ga—N, In—Ge, Ge—Ar, and combinations thereof. In another implementation, the nanowire is ZnO with an aspect ratio in the range of 5 to 500. In another implementation, the nanowire is ZnO with an aspect ratio in the range of 10 to 500. In another implementation, the nanowire is ZnO with an aspect ratio around 200.

The wt % of nanowires in the composite may be in the range of 0.01 to 50 wt %. In one implementation, the nanowire wt % in the composite fiber is in the range of 0.01 to 10 wt %. In yet another implementation, the nanowire wt % in the composite fiber is in the range of 0.5 to 2 wt %. In another implementation, the nanowire wt % in the composite fiber is 1.0 wt %.

### EXAMPLES

The disclosure will now be illustrated with working examples, which is intended to illustrate the working of disclosure and not intended to take restrictively to imply any limitations on the scope of the present disclosure. Other examples are also possible which are within the scope of the present disclosure.

Textile grade nylon 6 polymer (MFI ˜30) was procured from Grodno Khimvolokno-Republic of Belarus. Zinc Oxide nanostructures of various aspect ratio were synthesized as reported in our previous study using hydrothermal non-stirred vessel. The nanostructures used for the study includes nanoparticles (aspect ratio 1, diameter 50 nm), nanowires (aspect ratio 14) and nanowires (aspect ratio 200).

### Example 1

### Preparation of Composite Fiber Comprising ZnO Nanostructures

### Synthesis of ZnO Nanostructures (Nanoparticles and Nanowires)

The ZnO nanoparticles and nanowires (aspect ratio (AR) of 14) were synthesized using hydrothermal non stirred vessel. Zinc acetate dihydrate (Zn(Ac)₂.2H₂O) was used as precursor for the synthesis and NaOH as oxidizing agent. Ethanol was used as solvent for synthesis. The OH⁻/Zn²⁺ ratio used were 0 and 10 for nanoparticles and nanowires (AR=14) respectively. In a typical procedure, zinc acetate dihydrate (0.002 mole) was dispersed in 20 ml of ethanol. In the above dispersion, 40 ml of NaOH solution (with 0 and 0.02 mole of NaOH dissolved in 40 ml ethanol, respectively, for 0 and 10 ratio) was added drop wise. This mixture was then transferred to a non-stirred hydrothermal vessel and kept for 12 h at 150° C. Precipitate obtained was washed several times with water, finally with ethanol and then dried.

### Synthesis of ZnO Nanowires of Aspect Ratio 200

The nano sized, ZnO wires were synthesized using hydrothermal non stirred vessel as reported in the literature. In a typical procedure, zinc chloride, 1 gm and SDS, 5 gm was dissolved in 30 ml of DI water. In the above solution, 25 gm of Na₂CO₃ was added and final volume was made 70 ml. This mixture was stirred at 500 rpm for 10 min at 25° C. and then transferred to a non-stirred hydrothermal vessel and kept for 12 h at 150° C. Precipitates obtained were washed several times with hot water, finally with ethanol and then dried.

### Dispersion of ZnO Nanostructures in Nylon 6 Polymer

### (Physical Blending Followed by TSE Process)

0.5 wt %, 1 wt %, 1.5 wt % and 2 wt % ZnO nanostructures incorporated melt blended nanocomposite batches were prepared in twin screw extruder (TSE) Euro lab 16 of Thermo Scientific. The required quantity of ZnO nanostructures was dispersed in acetone by stirring for 15 min at 500 rpm followed by ultrasonication for 30 min in sonication bath (Elma, at 100% power and frequency of 35 kHz) ZnO wires/acetone dispersion and nylon 6 polymer chips were physically premixed, dried in vacuum oven at 110° C. for 24 h and stored in dry atmosphere flushed with nitrogen. The extrusion of ZnO nanostructures infused nylon 6 as well as neat nylon 6 was done using 16 mm diameter screw inside thermostatically controlled seven heating zones maintained at 230/235/240/240/245/250/255/255° C. respectively. The r.p.m of screw and feed rate were kept 100 and 15%, respectively.

The strands obtained after extrusion were palletized into small chips for melt spinning.

Samples were coded as follows:
Nylon 6 for control polymer fiber without ZnO;
0.5 ZnP/Nylon, 1 ZnP/Nylon, 1.5 ZnP/Nylon, 2 ZnP/Nylon for ZnO particles reinforced nylon fibers;
0.5 ZnR/Nylon, 1 ZnR/Nylon, 1.5 ZnR/Nylon, 2 ZnR/Nylon for nylon fibers reinforced with ZnO nanowires of aspect ratio 14; and
0.5 ZnW/Nylon, 1 ZnW/Nylon, 1.5 ZnW/Nylon, 2 ZnW/Nylon for nylon fibres reinforced with ZnO nanowires of aspect ratio 200.

ZnP means ZnO nanoparticles; while ZnP/Nylon are nylon fibres with ZnO particles,

ZnR means ZnO nanowire with aspect ratio 14; while ZnR/Nylon are nylon fibres with ZnO nanowire of aspect ratio 14

ZnW means ZnO nanowire of aspect ratio 200; while ZnW/Nylon means nylon fibres with ZnO nanowire of aspect ratio 200

Monofilament Spinning of Neat and ZnO/Nylon 6 Composite Fibers was Carried Out as follows:

### Melt Spinning

The melt blended chips obtained from the twin screw were dried in vacuum over for 6 hours under nitrogen blanket, stored in dry atmosphere flushed with nitrogen. These were spun into homo monofilament using Hills melt spinning machine. Spinning was carried out using single hopper system. The temperature of first heating zone was set at 240° C. followed by a second heating zone at 250° C. 0.97 g/min through put rate was maintained using metric pump at r.p.m 1.7. The spin pack was maintained at 250° C. for extrusion of monofilament. The obtained filaments were collected on a winder with surface speed of 81.25 m/min.

### DRAWING

As-spun neat and composite monofilaments were conditioned at 65% RH for 24 h. The conditioned filaments were drawn up to maximum draw ratio at room temperature (˜30° C.). The obtained composite fibers were characterized using Instron Tensile tester (Instron 4301 and Instron micro tester), Thermo gravimetric analysis (TGA), TGA Q500 and Differential scanning calorimetry (DSC), DSC Q200 (TA Instruments, New Castle, Del., USA). Samples of 5-10 mg fibres were quenched at −20° C., followed by heating up to 250° C. at a heating rate 10° C./min then cooled to room temperature at the rate of 2° C./min under nitrogen atmosphere at a flow rate 50 ml/min. Raman analysis was done using confocal laser dispersion micro Raman spectrometer (Model-INVIA, laser 785 nm⁻¹) from Renishaw, UK. X-ray diffraction (XRD) patterns were obtained from PANalytical X-ray diffractometer, with Cu K radiation (λ=0.154 nm) at 40 kV.

Samples were coded as follows:
Nylon 6 for control polymer fiber without ZnO;
0.5 ZnP/Nylon, 1 ZnP/Nylon, 1.5 ZnP/Nylon, 2 ZnP/Nylon for ZnO particles reinforced nylon fibers;
0.5 ZnR/Nylon, 1 ZnR/Nylon, 1.5 ZnR/Nylon, 2 ZnR/Nylon for nylon fibers reinforced with ZnO nanowires of aspect ratio 14; and
0.5 ZnW/Nylon, 1 ZnW/Nylon, 1.5 ZnW/Nylon, 2 ZnW/Nylon for nylon fibres reinforced with ZnO nanowires of aspect ratio 200.

### Thermal Studies

Thermal behavior of pure nylon 6 and ZnO/nylon 6 nanocomposite monofilaments was analysed using Thermo gravimetric analysis (TGA), TGA Q500 and Differential scanning calorimetry (DSC), DSC Q200 (TA Instruments, New Castle, Del., USA). Samples of 5-10 mg fibres were quenched at −20° C., followed by heating up to 250° C. at a heating rate 10° C./min then cooled to room temperature at the rate of 2° C./min under nitrogen atmosphere at a flow rate 50 ml/min.

### Mechanical Behavior

The tensile strength, initial modulus, elongation at break and energy at break of the drawn filaments of neat nylon and ZnO/Nylon 6 composite fibers was measured using Instron Tensile tester (Instron 4301 and Instron micro tester). For tensile properties diameter of each template was measured using optical microscope. 10N load cell was used with cross head speed of 300 mm/min. Mean values were average of 50 measurements for each sample. Tensile strength and modulus values of composite filaments were expressed in megapascal (MPa) unit.

### Morphology of ZnO Nanowires and Particles

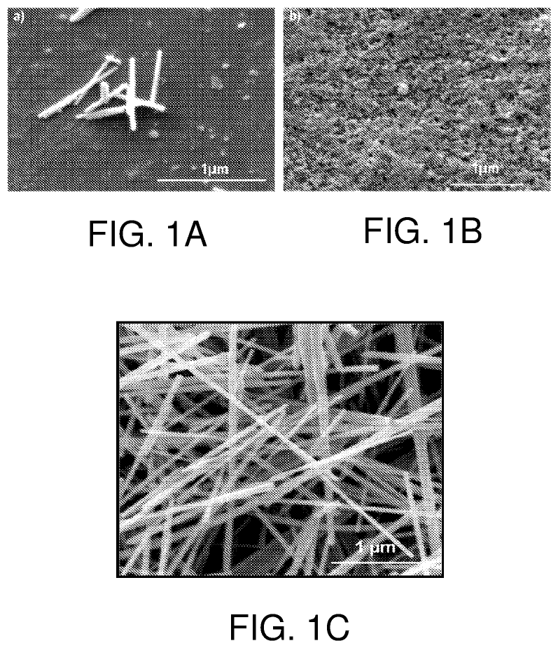

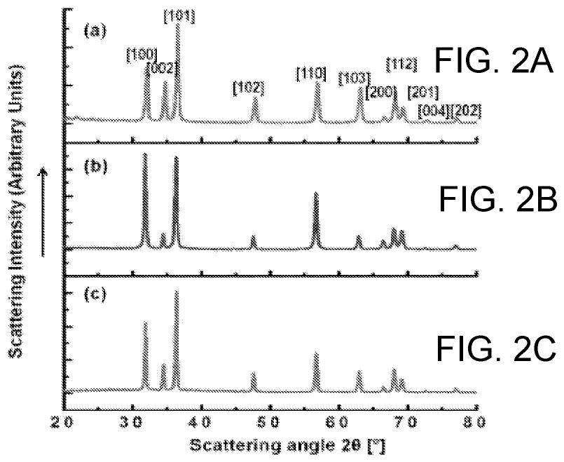

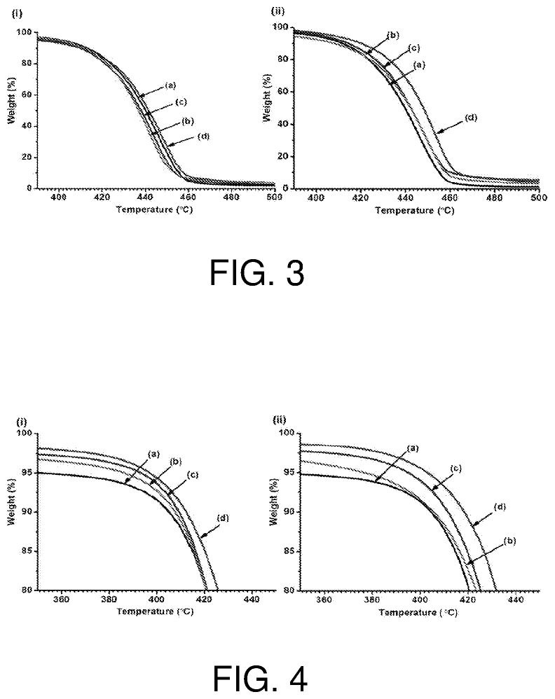

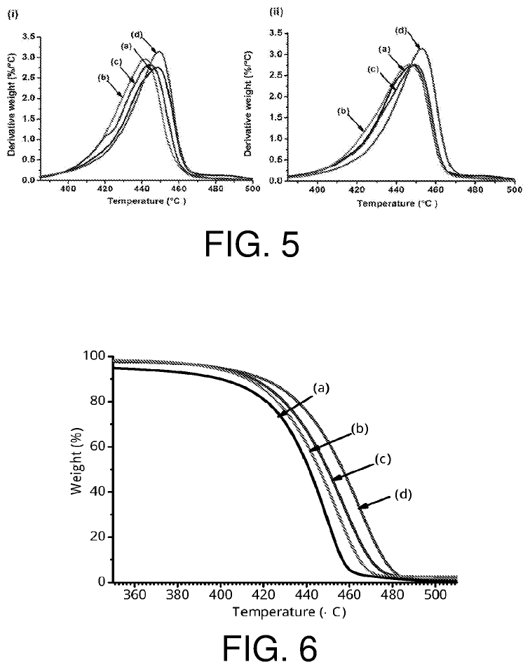

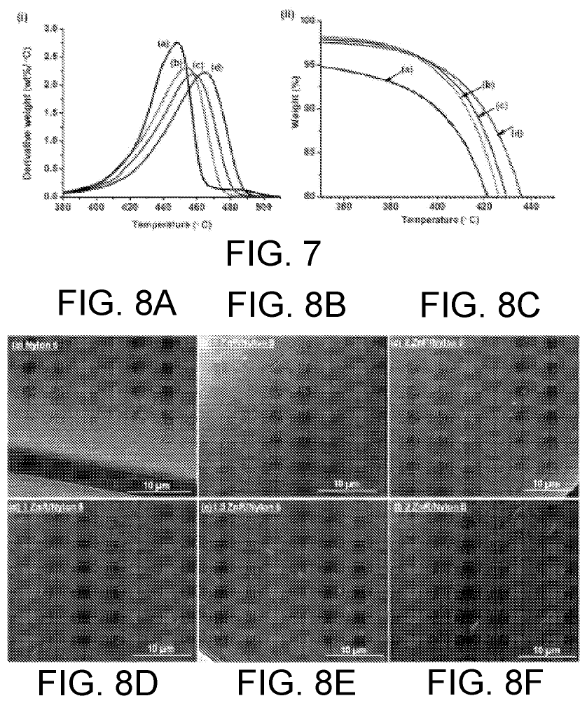

Morphology of ZnO nanorods, nanoparticles, and nanowires was analyzed using FE-SEM as shown in FIGS. 1A, 1B, and 1C respectively. The dimensions of the ZnO rods were determined as an average of 100 readings using Image J software. SEM study revealed that the synthesized ZnO nanowires of aspect ratio of ˜14 had average length of 691±167 nm and average diameter of 50±10 nm. The synthesized ZnO nanowires of aspect ratio of ˜200 had average length of 10 μm and average diameter of 50±10 nm. The ZnO structures showed a typical XRD pattern for high purity wurtzite hexagonal phase FIG. 2A-C and the entire diffraction pattern matched well with the standard hexagonal ZnO (JCPDS number 36-1451 for ZnO). As reported in the literature [Cheng et al], the nanoparticles grew along [001] direction to produce ZnO nanowires. XRD pattern of ZnO nanowires showed strongest reflections corresponding to [101] and [100] as compared to [002] planes as shown in FIG. 2.

### Thermal Behavior of Nanocomposite Fiber

TGA and DTG graphs for ZnO nanowires of aspect ratio 200 are shown in FIG. 4(i). The onset values of thermal degradation for Nylon, 0.5 ZnW/Nylon 6, 1 ZnW/Nylon 6 and 2 ZnW/Nylon 6 were observed to be at 390° C., 391° C., 396° C. and 400° C., respectively. FIG. 4(ii) shows derivative of weight loss (DTG curve) of neat nylon 6 and ZnO/nylon 6 composite fibers. The corresponding temperatures for the maximum rate of weight loss were observed at 449.2, 454, 457.6, and 465° C. respectively. As observed in FIG. 6, the composites containing ZnWs of aspect ratio 200 had maximum thermal stability followed by those with ZnRs and ZnPs. From the results it appears that the high aspect ratio of nanostructures has helped in better dissipation of thermal energy, which resulted in improved thermal stability of the composites. Incorporation of ZnW, which have a high aspect ratio, showed increased thermal stability, at all levels of additions (i.e. from 0.5 to 2 wt %). The morphology of melt spun ZnO/Nylon composite fibers is shown in FIG. 8. In all the cases, the surface of fibers was observed to be smooth. Moreover, no aggregates were observed in case of ZnO composite fibers. ZnO nanostructures were well dispersed.

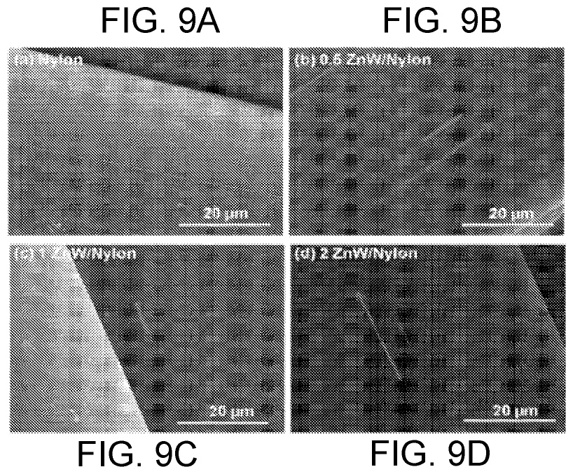

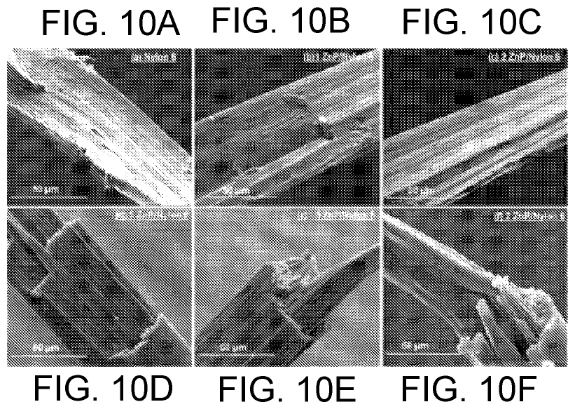

In ZnR/Nylon and ZnW/Nylon composite fibers, ZnO nanowires were found to be properly dispersed inside the nanofibers and also aligned along the axis of the fibers resulting in reinforced nanofiber structures. SEM images as shown in FIG. 9A-D further confirmed the proper dispersion and alignment of ZnO nanowires in Nylon fibers. The cross-section of composite fibers was prepared by fracturing the fiber in liquid nitrogen and observed under SEM as shown in FIGS. 10A-F and 11A-D. In case of composites containing nanowires the fibers with fibrillar structure were obtained and the cross section was found to be more oriented as compared to nylon and ZnP/nylon composite. The maximum orientation was observed in 1 ZnW/Nylon which attributed towards maximum strength as well as modulus in the composite fiber.

### Drawing Behavior of Composite Filaments

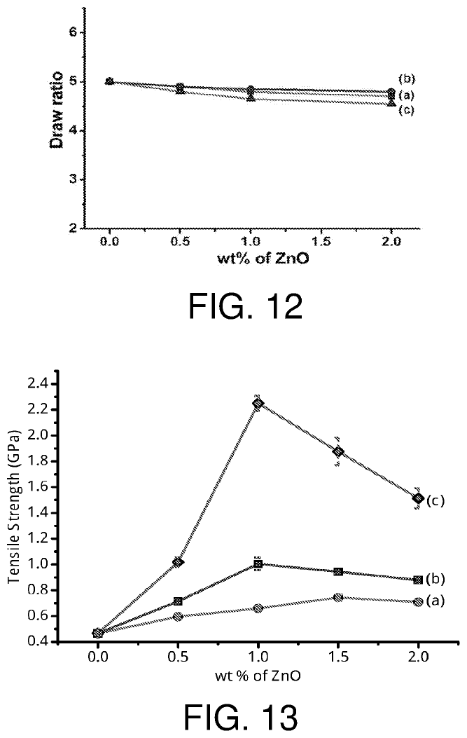

The obtained as-spun neat and composite monofilaments were conditioned at 65% RH for 24 h. The conditioned filaments were drawn up to maximum draw ratio at the room temperature (˜30° C.). The effect of aspect ratio on drawability of composite fibers is shown in FIG. 12. It was observed that incorporation of ZnO nanostructures have insignificant effect on the maximum draw ratio achieved. The ZnO nanostructures were not adversely affecting the drawing efficiency of nylon 6 fibers.

### Mechanical Behavior of Composite Filaments

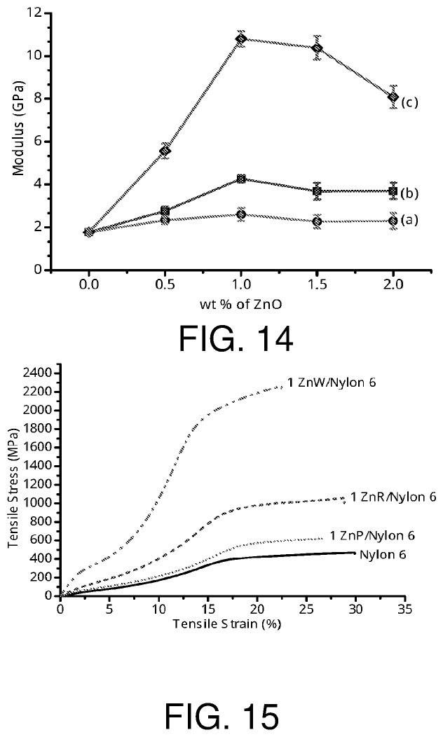

Tensile properties of pure nylon 6 and ZnO wires reinforced composite Nylon fibers are shown in FIGS. 13 and 14. The mechanical properties were found to be dependent upon the wt % of ZnO incorporated. The incorporation of ZnO nanostructures first improved the mechanical properties in 0.5 wt % followed by 1 wt %. The further increase in concentration of ZnO resulted in decrease in mechanical properties in 1.5 wt % and 2 wt %. However, the mechanical properties were better than nylon control at all the concentrations. It was observed that tensile breaking stress as well as Young's modulus of ZnO nanostructure incorporated nylon fibers were improved as compared to pure nylon 6 fiber. However, the improvement was maximum in case of maximum aspect ratio ZnO nanowires followed by ZnO nanowires of lower aspect ratio of 14 and ZnO nanoparticles (aspect ratio of 1). The incorporation of same wt % of ZnO nanostructure with different aspect ratio resulted in different mechanical properties indicating a clear role of aspect ratio of nanostructures in determining the structure of the composite fiber.

As shown in FIG. 15 the tensile stress vs strain curves for fibers incorporated with similar wt % ZnO nanoparticles and nanowires of two aspect ratios are different. The breaking stress of 2.28±0.21 GPa and Young's modulus of 10.8±1.7 GPa were found to be maximum in case of 1 ZnW/Nylon reinforced fibers. The 1 ZnR/Nylon reinforced were found to have tensile stress of 1.0±0.15 GPa and modulus of 4.26±0.74 GPa GPa. The 1 ZnP/Nylon composite fibers however resulted in marginal improvement in tensile stress to 0.66±0.07 GPa and modulus of 2.6±0.42 GPa as compared to nylon with tensile stress and modulus of 0.46±0.05 GPa and 1.7β0 0.28 GPa respectively. The improved mechanical properties resulted in improved work of rupture for various aspect

TABLE 1
Tensile behavior of nylon 6 and ZnO/Nylon 6 nanocomposite fibers.

| | | | Modulus | | |
|---|---|---|---|---|---|
| | Tensile stress (GPa) | Tensile | (GPa) | % Gain | % Gain |
| Sample Code | (CV %) | strain (%) | (CV %) | (Stress) | (Modulus) |
| Nylon | 0.466 (10.9) | 29.5 (11.8) | 1.767 (16.2) | — | — |
| 0.5ZnP/Nylon | 0.595 (10.5) | 29 (21.6) | 2.333 (20.7) | 27 | 32 |
| 1ZnP/Nylon | 0.660 (11.3) | 24.9 (16.1) | 2.600 (16.5) | 42 | 47 |
| 1.5ZnP/Nylon | 0.744 (13) | 26.67 (19.0) | 2.267 (25.3) | 60 | 28 |
| 2ZnP/Nylon | 0.708 (14) | 27.3 (24.7) | 2.300 (22.6) | 52 | 30 |
| 0.5ZnR/Nylon | 0.714 (11.9) | 29.0 (26.2) | 2.767 (16.3) | 53 | 57 |
| 1ZnR/Nylon | 1.004 (19.4) | 28.9 (26.3) | 4.267 (17.3) | 115 | 142 |
| 1.5ZnR/Nylon | 0.944 (6) | 26.4 (24.5) | 3.683 (14.9) | 102 | 108 |
| 2ZnR/Nylon | 0.879 (9.2) | 28.7 (22.4) | 3.700 (20.6) | 89 | 109 |
| 0.5ZnW/Nylon | 1.018 (15.7) | 23.2% | 5.566 (25.5) | 118 | 215 |
| 1ZnW/Nylon | 2.28 (9.3) | 22.2% | 10.8 (14.6) | 390 | 511 |
| 1.5ZnW/Nylon | 1.88 (19) | 16.9% | 10.38 (21.2) | 302 | 487 |
| 2ZnW/Nylon | 1.513 (21.4) | 16.8% | 8.083 (24.8) | 225 | 357 |

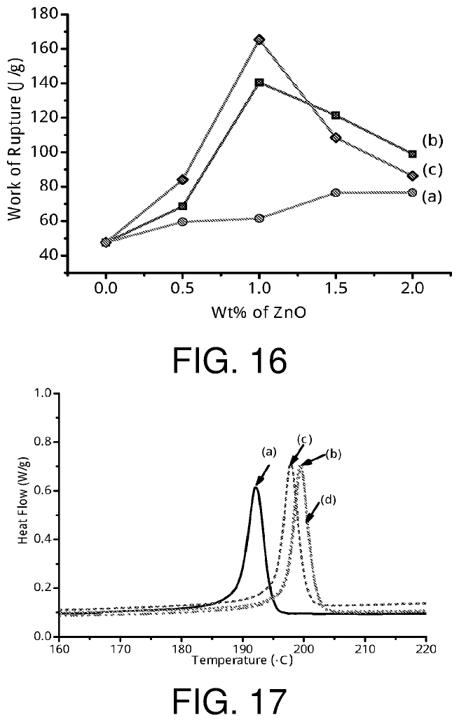

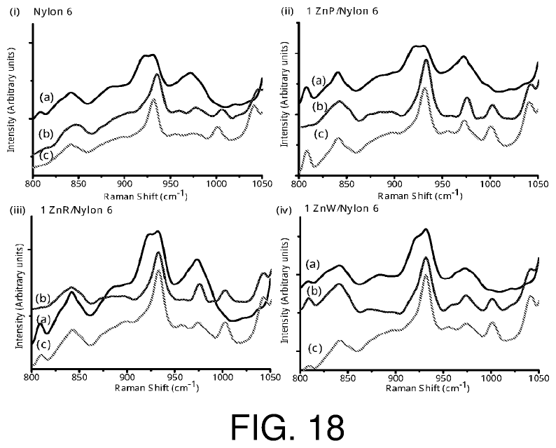

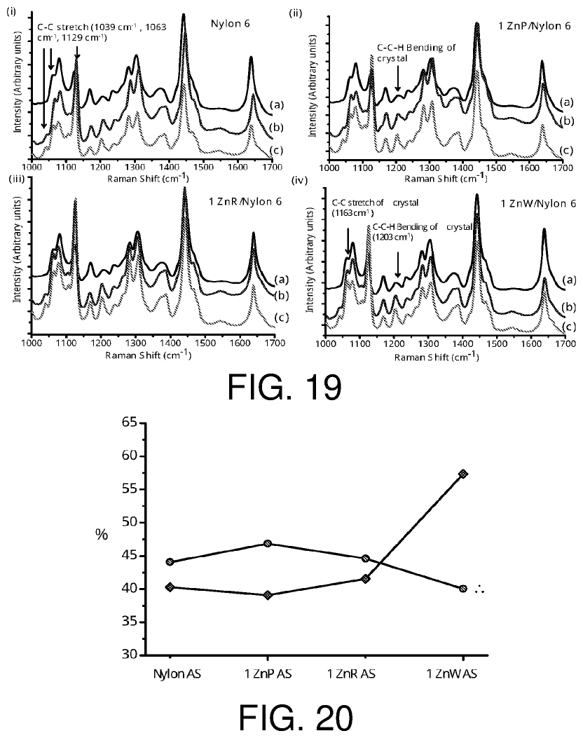

ratio of ZnO nanostructures. As shown in FIG. 16 the maximum work of rupture achieved was 165 J/g in 1 ZnW/Nylon composite fibers which is equivalent to that of dragline spider silk. It can clearly be seen that fibers with higher aspect ratio ZnO nanowires have better mechanical properties when used for reinforcement at various wt % of incorporation as compared to other fibers.

### Crystallization Behavior of Composite Fiber

Differential scanning calorimetric analysis was carried out to determine crystallization temperature (T_{c}) of Nylon 6 and composite fibers as shown in FIG. 17. ZnO/Nylon 6 nanocomposite fibers were found to have higher T_{c} in the range of 193 to 203° C. compared to 192° C. observed in Nylon 6 fibers. This increase in T_{c} indicated that ZnO nanostructures were able to induce nucleation at higher temperature due to the association of polymer chains with the nanostructures. Addition of high aspect ratio structures (i.e. ZnR and ZnW) appear to have a greater influence in nucleation resulting in higher T_{c} than fibers having ZnP.

### Structural Analysis of Composite Fibers

### (a) By Raman Spectroscopy

The structure of the composite fibers reinforced with ZnO nanostructures of different aspect ratios was investigated using Raman analysis and was correlated with mechanical properties of the fibers. The samples used for the study were as-spun (AS), drawn (DR) and drawn and heat-set (HS) of Nylon 6, 1 ZnP/Nylon 6, 1 ZnR/Nylon 6 and 1 ZnW/Nylon 6.

Nylon 6 has been reported to crystallizes in γ and α crystalline forms. The α crystal is thermodynamically more stable form having a zigzag conformation with molecular chains lying antiparallel to each other and bonded with hydrogen bonds to form planar sheets. The γ crystal on the other hand has parallel chains, which have kinks to facilitate the formation of hydrogen bonds. Raman spectra were analyzed to understand the effect of incorporation of ZnO nanostructures of different aspect ratios on relative proportions of γ and α crystalline forms in the obtained fibers. Raman spectra are shown in FIGS. 6.15 and 6.16 for two different regions of 800 to 1050 cm⁻¹ and 1000 to 1700 cm⁻¹, respectively.

The peaks in the region of 900 to 1000 cm¹ were deconvoluted. The assigned peak values used for the deconvolution are listed as.

| Vibration type | α | γ |
|---|---|---|
| CO—NH in plane | 934 (m) | 921 (m) |
| CO—-NH in plane | 960 (m) | 978 (m) |
| C—C stretch | 1001 (m) | — |
| C—C stretch | 1039 (w) | — |
| C—C stretch | 1063 (m) | 1060 (m) |
| C—C stretch | 1078 (m) | 1081 (ws) |
| C—C stretch | 1129 (vs) | 1121 (m) |
| C—C—H bending | 1203 (m) | — |
| CH₂ Wagging | 1386 (m) | — |
| Amide III | 1281 (m) | — |
| CH₂ Bending | 1445 (vs) | 1441 (vs) |
| Amide I (C═0) | 1636 (vs) | 1636 (vs) |

The deconvoluted peaks at 921, 934, 960, 978 and 985 cm⁻¹ were selected for comparing the relative content of α and γ crystal forms. The peaks at 921 and 978 cm⁻¹ correspond to γ crystals, 934 and 960 cm⁻¹ correspond to α crystals. The peaks of as-spun (AS), drawn (DR) and drawn and heat-set (HS) samples of Nylon 6, 1 ZnP/Nylon 6, 1 ZnR/Nylon 6 and 1 ZnW/Nylon 6 were deconvoluted for the region 890 to 1000 cm⁻¹ for calculating the relative content of α and γ crystal forms.

The content of γ and α crystalline forms in as-spun samples was found to be dependent upon the aspect ratio of nanostructures used as shown in FIG. 20. The γ and α content in percentage has been calculated by calculating the total area under two peaks of normalized and deconvoluted Raman spectra for 921 and 978 cm⁻¹ for γ % and 934 and 960 cm⁻¹ for α %. The nylon 6 fibers reinforced with ZnP (aspect ratio 1) were found to have slightly higher γ content of 47% compared to 44% of Nylon 6-AS fibers. This increase was a result of both the decrease in the α content and the amorphous content. The results indicated that incorporation of ZnP supported the formation of γ crystals. As the aspect ratio of ZnO nanostructures was increased to 14, as in the case of 1 ZnR/Nylon 6-AS, the α crystal content was found to increase to 41.5%, while the γ content remained same as that of Nylon 6-AS. Further increase in the aspect ratio of ZnO nanostructure to 200, as in the case of ZnW, resulted in dramatic increase in α content to 57.3% with a corresponding drop in γ content to 40% and amorphous content to 2.6%. This clearly indicated that formation of α crystals was favored by incorporation higher aspect ratio ZnO nanostructures.

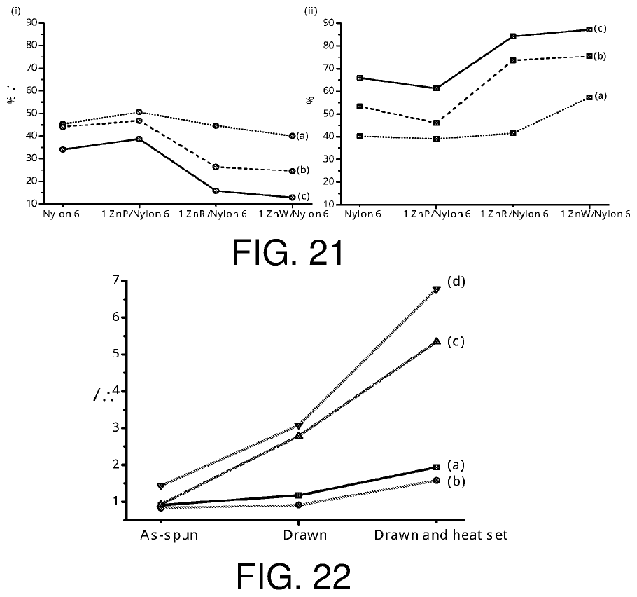

The effect of aspect ratio on α and γ content of as-spun, drawn and drawn and heat-set samples resulted in α/γ ratio as shown in FIGS. 21 and 22. It has been observed that, high γ content of nylon 6 fibers converted to α on successive drawing and heat setting. This resulted in increased α/γ ratio in drawn and drawn and heat set nylon 6 fibers to 1.18 and 1.9, respectively, compared to 0.91 of as-spun nylon 6 fibers. The incorporation of ZnPc (Aspect Ratio 1) which hindered the growth of a phase resulted in α/γ ratio of 0.83, 0.91 and 1.58 in AS, DR and HS fibers, respectively. The incorporation of ZnR (ZnO nanowires of aspect ratio 14), which though resulted in small increase of a phase in the as spun fibers (i.e. α/γ ratio of 0.93, which was similar to Nylon 6 fibers), favored ready conversion of γ→α crystals on drawing and heat setting. The increased α content in ZnR samples resulted in substantial increase in α/γ ratio to 2.79 and 5.34 in DR and HS composite fibers. On the other hand, the high aspect ratio ZnW (ZnO nanowires of aspect ratio 200) favored the formation of α crystals during the melt spinning of as-spun fibers. Also, it supported the conversion of γ→α crystals in drawn as well as drawn and heat set fibers. This resulted in high values of α/γ ratio of 1.43, 3.08 and 6.78 in AS, DR and HS ZnW composite fibers, respectively.

### (b) By DSC

### Melting Behavior of Composite Fibers

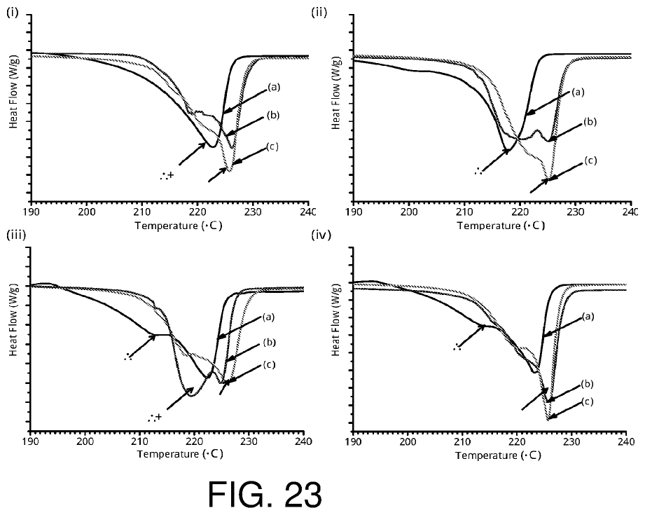

FIG. 23 shows the DSC curves for Nylon 6, 1 ZnP/Nylon 6, 1 ZnR/Nylon 6 and 1 ZnW/Nylon 6 samples. Melting peak temperature of Nylon 6-AS was found to be in the form of a single broad peak from 200-224° C. The nylon 6 contains both γ and α crystalline forms, which melt at 214° C. and 220° C., respectively. The broad peak in Nylon 6-AS corresponds to a mixture of α and γ crystals. As the sample was drawn in Nylon 6-DR, the broadness of the peak decreased and the peak was found to segregate into two peaks at 218° C. (α+γ) and 226° C. (α). The peak at 218° C. may be attributed to mixture of γ and α crystals (formed via γ→α conversion on drawing). However, the lower temperature indicates that α crystals formed from γ have less alignment, more free volume and less stability. When the same sample was heat set at 150° C., increase in the intensity of peak at 226° C. and further shift in second peak at 220° C. in the form a hump was observed. This clearly indicates that stability of α crystals formed via conversion from γ has been increased. The Nylon 6-HS fibers have mainly α crystals with higher content of α crystals with less free volume/more stability and few α crystals with higher free volume/less stability.

1 ZnP/Nylon 6-AS showed a single broad peak at 200-220° C. shifted left indicating more γ which clearly indicates the presence of γ crystal on incorporation of ZnO nanoparticles. As the sample was drawn 1 ZnP-DR, similar to Nylon 6 the peak was found to be segregated in two peaks 218° C. and 224° C. However, the peak at 218° C. is still broad & strong. This indicates that although drawing facilitates the γ→α conversion, the conversion is still not complete and the γ crystals with broad distribution of melting point are present. Heat setting further facilitates the γ→α conversion.

1 ZnR/Nylon 6-AS fibers resulted into melting curve with two peaks, a small shoulder at 214° C. and strong peak at 222° C. attributed to γ and α crystals respectively. The drawing facilitates the γ→α conversion in 1 ZnR/Nylon 6-DR, which results into an α+γ peak, which is sharper than that in 1 ZnP/Nylon 6 indicating higher conversion of γ to alpha having relatively lower melting point. Another peak at higher melting point at 224° C. corresponding to more stable α phase is also present. Further in 1 ZnR/Nylon 6-HS the peak at 224° C. shifts further to 226° C.

Further increasing the aspect ratio to 200 in 1 ZnW/Nylon 6-AS resulted mainly a peak at 224° C. for α crystals, with a small shoulder at 214° C. for γ crystals. The higher melting temperature of α crystals as compared to other samples indicates that even in the as-spun sample, α crystals formed are of higher stability (i.e. the free volume), indicating ZnW in promoting the formation of better crystalline phase. In 1 ZnW/Nylon 6-DR, the peak becomes sharper and further shifts to 226° C. Interestingly, there is no peak at 218° C. and only a small hump at 220° C. was observed, which indicates that presence of ZnW facilitated the conversion of γ crystals to more stable α crystals. On heat setting, the α peak becomes more defined and narrower at 226° C. in 1 ZnW/Nylon 6-HS.

### (c) By XRD

### (i) Crystalline Phase

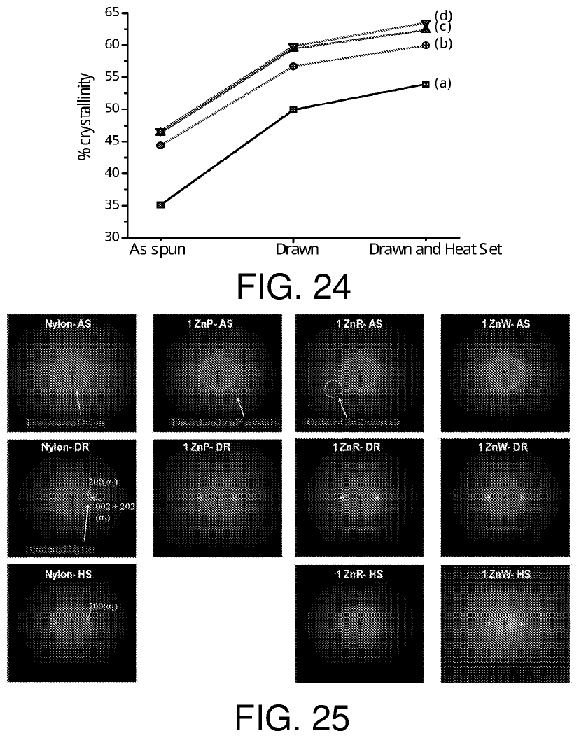

FIG. 24 shows the effect of aspect ratio on the total crystallinity of the fibers. The percentage crystallinity of drawn and heat-set fibers increases from 54% in Nylon-6 fibers to 59-63.5% in composite fibers.

To further understand the effect of ZnO nanostructure's aspect ratio on crystal structure the crystalline peaks in XRD were analyzed. The spectra are shown in FIG. 25. The as-spun samples were found to have sharp crystalline rings indicating unoriented crystalline phase. Interestingly, the crystalline peaks for ZnO have distinctly different pattern. In 1 ZnR/Nylon 6-AS and 1 ZnW/Nylon 6-AS, peaks related to ZnR and ZnW were seen as sharp arcs indicating that the anisotropic ZnO nanostructures were aligned along the fiber axis. On the other hand, 1 ZnP/Nylon 6 samples showed sharp rings for ZnO crystals resulting from unoriented nanoparticles. The drawn and heat set samples were found to have better orientation of α and γ crystals resulting into the change of rings to sharp arcs.

The γ and α content was calculated from the area under the deconvoluted XRD peaks. The α crystalline forms were taken at 2θ=20.5 (scattering vector q=14.5) and 2θ=23.5 (scattering vector q=17) and labeled as α₁ and α₂. The γ crystalline forms were considered at 2θ=21.5 (scattering vector q=15.25) and 2θ=23 (scattering vector q=16.25), which correspond to γ₁ and γ₂. The amorphous region was fitted at 2θ=20 (scattering vector q=14.25).

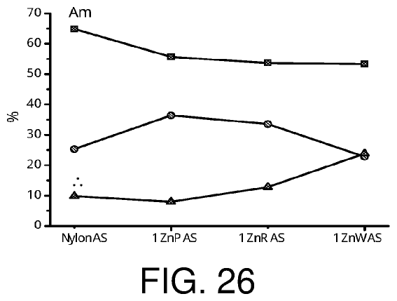

The content of γ and α crystalline forms in as-spun samples was found to be dependent upon the aspect ratio of nanostructures used as shown in FIG. 26. The nylon 6 fibers reinforced with ZnP had 36.4% γ as compared to 25.3% of Nylon 6-AS fibers. However, the α and amorphous contents were lower at 9.96% and 55.6% compared to 9.8% and 64.9% in Nylon 6-AS. This showed that incorporation of ZnP in nylon 6 resulted in formation of γ crystals during melt spinning. As the aspect ratio of nanostructures was increased to 14, as in the case of 1 ZnR/Nylon 6-AS, the α crystal content increased to 12.8%. The γ also increased to 33.6% with further reduction in amorphous content to 53.6%. Further increase in aspect ratio to 200 in ZnW resulted in a drastic increase in a content to 23.9% with decrease in γ to 22.8%, while the amorphous content was similar to ZnR sample at 53.4%. This clearly indicates that γ crystal formation was favored by the presence of low aspect ratio nanostructures such as ZnP (aspect ratio of 1) and ZnR aspect ratio of 14), while nanostructures with very high aspect ratio of 200 i.e. ZnW resulted in formation of more of α crystals during the melt spinning process.

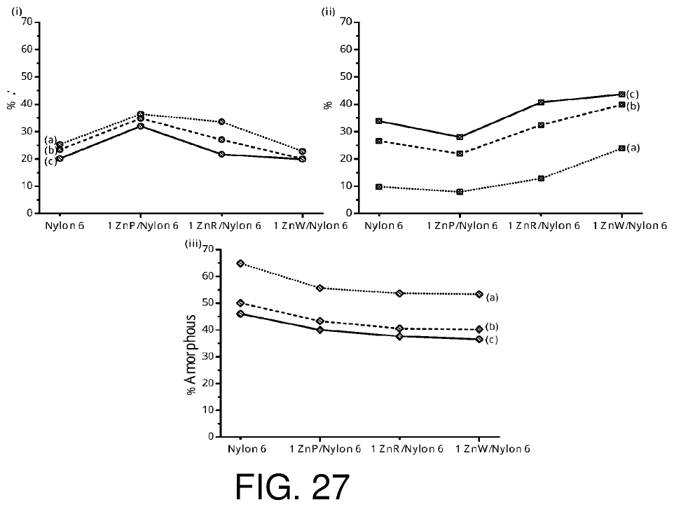

It was observed that on drawing, a part of γ was converted to a resulting in decrease of γ content in all the fibers as shown in FIG. 27. The γ content was 23.4, 34.8, 27.0 and 20.0% in drawn fibers of Nylon 6, 1 ZnP/Nylon 6, 1 ZnR/Nylon 6 and 1 ZnW/Nylon 6, respectively. The α content was found to increase significantly to 26.6, 21.9, 32.4 and 39.8% in drawn fibers of Nylon 6, 1 ZnP/Nylon 6, 1 ZnR/Nylon 6 and 1 ZnW/Nylon 6, respectively. The increase in α content was because of the conversion of both γ and amorphous phases to a phase. The amorphous content was found to reduce to 50.1, 43.3, 40.5 and 40.2 in drawn fibers of Nylon 6, 1 ZnP/Nylon 6, 1 ZnR/Nylon 6 and 1 ZnW/Nylon 6, respectively.

Drawn and heat-set fibers further resulted in increased α content of 33.9, 28.0, 40.7 and 43.6% and decreased γ content of 20.1, 31.9, 21.7 and 19.9% in Nylon 6, 1 ZnP/Nylon 6, 1 ZnR/Nylon 6 and 1 ZnW/Nylon 6, respectively. Heat-setting further reduced the amorphous content to 46.0, 40.0, 37.6 and 36.5%, respectively.

From the above results, it may be observed that as-spun Nylon 6 fibers had more of γ content, which could decrease marginally on conversion to a on successive drawing and heat-setting. The incorporation of ZnP favored the formation of still higher content of γ phase during melt spinning, which on drawing and heat-setting could not effectively transform to a phase, resulting in low α/γ ratio in all ZnP samples. On the other hand, the incorporation of ZnW (aspect ratio of 200) favored the formation of α crystalline phase even during the melt spinning process, which further improved on drawing and heat-setting. The formation of γ phase was found to be limited in these fibers. Interestingly, ZnR (ZnO nanowires with aspect ratio of 14), could not limit the formation of high γ content during the melt spinning process. However, ZnR favored the conversion of γ to a on subsequent drawing and heat-setting. This resulted in drastic improvement of α/γ ratio for the final drawn and heat-set fibers containing ZnR. The above results based on x-ray analysis support the results obtained from Raman studies. In both, the α/γ ratio was maximum in the fibers reinforced with highest aspect ratio ZnW followed those with ZnR. The fibers with ZnP had more γ content resulting in the lowest α/γ ratio. The results confirmed that incorporation of high aspect ratio ZnO nanostructures facilitates the formation of α crystals during the melt spinning process and conversion of γ→α crystals upon drawing and heat setting.

### (ii) Crystalline Phase Anisotropy

The crystalline phase anisotropy was determined by taking a p scan of a strong crystalline peak at 20.5 and 23.5 for α₁ and α₂ respectively and using the procedure mentioned in experimental section.

TABLE 2
Crystalline orientation factor for drawn nylon 6 fibers

| Sample | fc (α₁) | fc (α₂) |
|---|---|---|
| Nylon 6 | 0.914 | 0.914 |
| 1 ZnP/Nylon 6 | 0.8939 | 0.9179 |
| 1 ZnR/Nylon 6 | 0.926 | 0.921 |
| 1 ZnW/Nylon 6 | 0.929 | 0.938 |

(iii) Amorphous Phase Anisotropy

The oriented fraction of amorphous content was calculated from the deconvoluted peaks of X-ray diffraction using the procedure mentioned in the experimental section. The fraction was calculated as the area of amorphous peak above the baseline to that of the of the total amorphous content.

TABLE 3
Fraction of oriented molecules in the amorphous
region of composite fibers.

| | Fₒₐ | Fₒₐ | Fₒₐ |
|---|---|---|---|
| Sample | As Spun | Drawn | Drawn and Heat Set |
| Nylon | 0.117 | 0.472 | 0.494 |
| 1-ZnP/Nylon | 0.103 | 0.449 | 0.468 |
| 1-ZnR/Nylon | 0.157 | 0.518 | 0.537 |
| 1-ZnW/Nylon | 0.171 | 0.541 | 0.549 |

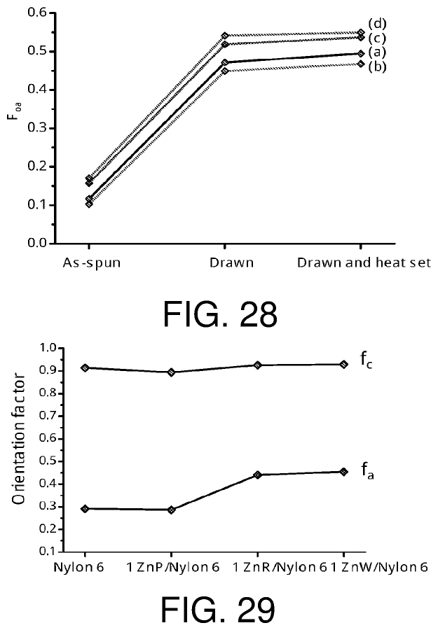

As shown in FIG. 28, the oriented fraction of amorphous content was found to increase with drawing and heat setting for all the samples. However, the incorporation of nanowires, ZnR and ZnWs resulted in increased oriented content. On the other hand, composites containing ZnP showed lower extent of amorphous orientation. From the results it may be inferred that the presence of high aspect ratio nanostructures could not only increase the conversion of amorphous to crystalline crystalline regions in composite fibers, but also help in the orientation of amorphous fraction during the post-spinning processes. The improvement was found to be maximum in the heat set ZnW reinforced fibers.

### (d) By Birefringence

The birefringence values for different fibers (drawn) are given in Table. The birefringence data was used for the calculation of amorphous orientation (fₐb) using the expression:

Δ=f_{ab}(1−χ_{c})Δₐ+f_{c}χ_{c}Δ_{c}

Where, f_{c} is (α₁) crystalline orientation, Δ is measured birefringence value, χ_{c} is crystallinity, Δₐ and Δ_{c} are intrinsic optical birefringence of the amorphous and crystalline domains. The values for Δₐ and Δ_{c} were taken as 0.078 and 0.089, respectively. The values of χ_{c} and f_{c} were taken from XRD analysis as mentioned above.

The composite fibers with high aspect ratio ZnO nanostructures, which showed higher birefringence values, also had higher tensile strength and modulus. 1 ZnW/Nylon 6 with the highest birefringence showed the best mechanical properties. This indicates that addition of high aspect ratio nanostructures resulted in better orientation of the amorphous and crystalline regions as compared to the control nylon 6.

The birefringence values were found to increase from fibers of Nylon 6 to that of composite, except for 0.5 ZnP/Nylon 6. The values increased dramatically up to 1 wt % of ZnO nanostructures. Thereafter the values were found to decrease, though these still remained high compared to the neat nylon 6.

TABLE 4
Birefringence values for drawn composite nylon fibers.

| Wt % ofZnO | ZnP/Nylon 6 | ZnR/Nylon 6 | ZnW/Nylon 6 |
|---|---|---|---|
| 0 | 0.052 | 0.052 | 0.052 |
| 0.5 | 0.0518 | 0.0589 | 0.0618 |
| 1 | 0.056 | 0.0636 | 0.0639 |
| 1.5 | 0.0557 | 0.0618 | 0.0589 |
| 2 | 0.055 | 0.0623 | 0.0557 |

FIG. 29 shows the calculated f_{ab} values for the drawn composite fibers along with their f_{c} values. Table 4 shows the values of crystallinity %, its orientation factor, amorphous percentage and its orientation factor for the selected drawn fibers. The results show that the presence of anisotropic ZnO nanostructures in nylon 6, during its melt spinning and drawing, result in
(a) higher conversion of amorphous to highly oriented α crystalline regions
(b) increased orientation of remaining amorphous region

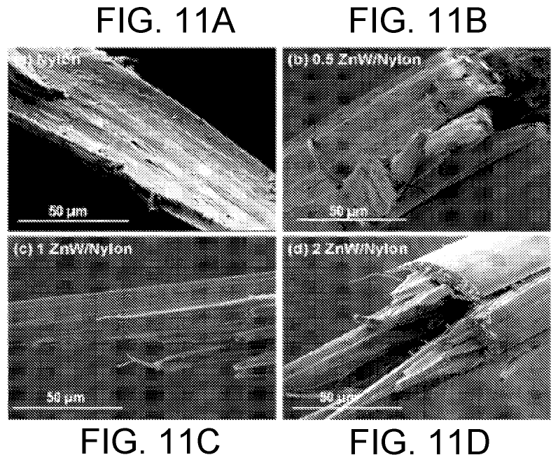

The above changes in internal morphology of the composite fibers is expected to result in formation of improved fibrillar structure, which correlates well with the observed SEM images shown in FIGS. 10 and 11.

TABLE 5
Structural characteristics of drawn nylon 6 and composite fibers.

| | | Crystalline | | Amorphous |
|---|---|---|---|---|
| | Crystallinity | orientation | Amorphous | orientation |
| Sample | % | (f_{c}) | % | (f_{ab}) |
| Nylon 6 | 49.9 | 0.914 | 50.1 | 0.291 |
| 1-ZnP/Nylon 6 | 56.7 | 0.8939 | 43.3 | 0.286 |
| 1-ZnR/Nylon 6 | 59.5 | 0.926 | 40.5 | 0.441 |
| 1-ZnW/Nylon 6 | 59.8 | 0.929 | 40.2 | 0.455 |

### Proposed Model for Composite Fibers

The properties of composites are dependent on interfacial interaction of polymer matrix with the reinforcing rigid structures. These have been modelled using various approaches. Among them, Pukanszky model has been used for determination of interphase interactions in particulate-polymer composites. The model is very versatile and has been used in many types of polymer-rigid structure composites. The same model has been used to evaluate the interaction in the composite fibers. Normalized tensile strength (σ_{c}/χ_{c})/(σ_{b}/χ_{b}) was used for the calculations.

According to the model,

(σ_{c}/χ_{c})(σ_{b}/χ_{b})=(1−φ_{f}/1+2.5φ^{f}) exp B_{σ}φ_{f}

### Where,

σ_{c} is tensile strength of composite
σ_{b} is Tensile strength of polymer matrix
χ_{c} is crystallinity of composite
χ_{b} is crystallinity of the matrix
φ_{f} is the volume fraction
B_{σ} is related to the load carried by dispersed phase

The term (1−φ_{f}/1+2.5 φ_{f}) expresses the effective load-bearing cross-section of the matrix.

The B_{σ} values for ZnO nanostructures of various aspect ratios were calculated from the experimental results and are listed in Table

TABLE 6
Values of interaction parameter Bo for different compositions of
nylon 6 fibers.

| | | Nanoparticles | B_{σ} | Nanowires |
|---|---|---|---|---|
| ZnO | | (Aspect | Nanorods | (Aspect |
| Wt % | φ_{f} | ratio = 1) | (Aspect ratio = 14) | ratio = 200) |
| 0.5 | 0.001 | 207.5 | 358.8 | 688.9 |
| 1 | 0.002 | 108.4 | 292.8 | 690.3 |
| 1.5 | 0.003 | 103.6 | 178.5 | 401.2 |
| 2 | 0.004 | 89.4 | 127.9 | 253.4 |

It has been observed that for ZnP and ZnR, the maximum interaction was for φ_{f}=0.001. Further increasing the volume fraction resulted in gradual decrease in interaction. However, ZnW showed almost the same interaction at volume fractions of 0.001 and 0.002. ZnW reinforced composite fibers had significantly higher values of B_{σ} at same values of φ_{f}, indicating enhanced interphase interaction.

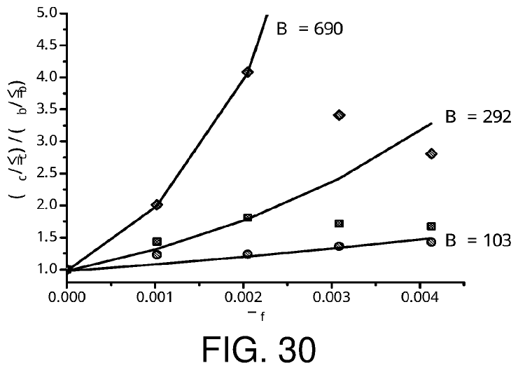

The normalized relative tensile strength values (σ_{c}/χ_{c})/(σ_{b}/χ_{b}) of the composite fibers were plotted as functions of pf. As shown in FIG. 30, the values were found to fit best at B_{σ} values of 103, 292 and 690 for composite samples having ZnP, ZnR and ZnW, respectively. The model fits reasonably well for samples with ZnP, however, for samples with ZnR and ZnW (i.e high aspect ratio structures), the fit was appropriate only till filler volume fraction of 0.002 or weight fraction of 0.01. At higher filler content, the values deviate significantly indicating poorer interaction of ZnR and ZnW possibly due to the aggregation of the nanostructures inside the fiber.

### Example 2

### Preparation of Halloysite Nanoclay (HNT) Reinforced Melt Spun Nanocomposite Filaments

Halloysite nanoclay (HNT) is one of the naturally occurring aluminosilicate clay (Al₂Si₂O₅(OH)₄, 2H₂O with 1:1 layer) with hollow micro and nanotubular structure. Textile grade nylon 6 polymer (MFI avg 31) was obtained from Grodno Khimvolokno-Republic of Belarus. Halloysite nanoclay was procured from Imerys Tableware LTd, New Zealand. The elemental compositions of the clay was (wt %): SiO₂, 49.5; Al₂O₃, 35.5; Fe₂O₃, 0.29; TiO₂, 0.09. The clay had surface area of 20 m²/gm; specific gravity of 2.55 g/cm³; cation exchange capacity of 10 meq/g, brightness (L*) of 98.9 under D65 light source, pH (aqueous slurry at 20% solids) of 3.5-4.5 and moisture content of 3%.

### Melt Blending of HNT Clay in Nylon 6 Polymer

### Using Method I (Physical Blending Followed by TSE Process)

0.5 wt % and 0.9 wt % HNT loaded melt blended nanocomposite batches were prepared in twin screw extruder (TSE) Euro lab 16 of Thermo Scientific. The required quantity of HNT clay and nylon 6 polymer chips were physically premixed, dried in vacuum oven at 110° C. for 24 h and were handled in desiccator containing P₂O₅(RH 0%). The extrusion of HNT infused nylon 6 as well as neat nylon 6 was done using 16 mm diameter screw inside thermostatically controlled ten heating zones maintained at 220/240/240/240/240/250/250/250/240/240° C. respectively. The r.p.m of screw and feed rate were kept 150 and 15%, respectively. The strands obtained after extrusion were palletized into small chips for melt spinning. HNT-nylon6 nanocomposites were coded as: Nylon 6, 0.5 HNT/Nylon 6 and 0.9 HNT/Nylon 6 respectively.

Using Method II (Physical Blending with Silicone Oil Followed by TSE Process)

In the second approach, 1.21 wt % HNT loaded nylon 6 melt blended batch was prepared with 1% silicon oil on the weight of the polymer clay mix to enable adherence of HNT on nylon 6 chips and hence proper dispersion of HNT inside nylon 6. The parameter of extrusion was kept as per the above procedure described in method I. HNT-nylon6 nanocomposite was coded as: 1.21 HNT/Si-Nylon 6

### Monofilament Spinning of Neat and HNT/Nylon 6 Composite Fibers

### Melt Spinning

The melt blended chips obtained from the twin screw were dried in vacuum over for 6 hours, handled with dedicator containing P₂O₅ for 0% RH conditions. These were spun into homo monofilament using Hills melt spinning machine. Spinning was carried out using single hopper system. The temperature of first heating zone was set at 240° C. followed by a second heating zone at 250° C. 0.97 g/min through put rate was maintained using metric pump at r.p.m 1.7. The spin pack was maintained at 250° C. for extrusion of monofilament. The obtained filaments were collected on a winder with surface speed of 81.25 m/min.

### DRAWING

As-spun neat and composite monofilaments were conditioned at 65% RH in desiccators with NaNO₂ for 24 h. The conditioned filaments were drawn up to maximum draw ratio in two steps on an in house designed drawing machine maintaining hot plate temperature at 50° C. and 110° C. respectively.

### Characterization

### Structural and Morphological Studies

The surface morphology of HNT nanoclay and the HNT/nylon 6 composite filaments was observed under the scanning electron microscope (Quanta 200 FEG). In order to analyze the nanotubular structure of halloysite powder, a small amount of HNT was sonicated in water for 1 h and then one drop of dispersed HNT was placed on the coverslip and dried in oven at 70° C. Crystal structure of HNT and drawn filaments was investigated using PAN analytical Xpert PRO X-ray diffractometer. The Cu Kα radiation source was operated at 40 kV and a current of 30 mA in a combination with NI filter. Patterns are recorded by monitoring the diffractions that appeared from 5° to 40° at a scan speed of 2.4° C./min.

Small angle X-ray scattering (SAXS) was performed using SAXS, Anton Paar, Austria. The Cu Kα radiation source having wavelength of 0.154 nm was operated at 40 kV and a current of 30 mA. Spectra of each sample were analyzed using SAXSQUANT and GIFT software.

### Thermal Studies

Differential scanning calorimetry (DSC) measurements were carried out on DSC 200 (TA Instruments, New Castle, Del., USA) to analyze the thermal behavior of pure nylon 6 and HNT/nylon 6 nanocomposite monofilaments. Samples of 5-10 mg fibres were quenched at −20° C., followed by heating up to 250° C. at a heating rate 10° C./min then cooled to room temperature at the same heating rate under nitrogen atmosphere at a flow rate 50 ml/min.

### Mechanical Behavior

### Tensile Test

The linear density of obtained filaments was determined on the weight of 5 m filament and was expressed in denier. The tensile strength, initial modulus, elongation at break, of the drawn filaments of neat nylon and HNT/Nylon 6 composite fibers was conducted on Instron Tensile tester (Instron 4301 and Instron micro tester). For tensile properties diameter of each template was measured using optical microscope. The fiber strands were placed on the window template axially with the help of scotch tape. 10N load cell was used with gauge length kept at 50 mm and speed of 300 mm/min. Mean values was averages of 15 measurements for each sample. Tensile strength and modulus values of composite filaments were expressed in megapascal (MPa) unit.

### Creep Test

To study the time dependent aspects of mechanical properties of nanocomposite filaments, creep test of pure nylon 6, 0.5 HNT/Nylon 6 and 1.21 HNT/Si-Nylon 6 nanocomposite filaments was performed. A constant load was applied (10% of the breaking strength of filaments) to the filaments and the creep (extension) was measured after various times of loading. Measurements were taken instantly just after loading and every 5 minutes for next 1 hour and thereafter at long interval of 24 h after the application of load.

### Characterization of HNT

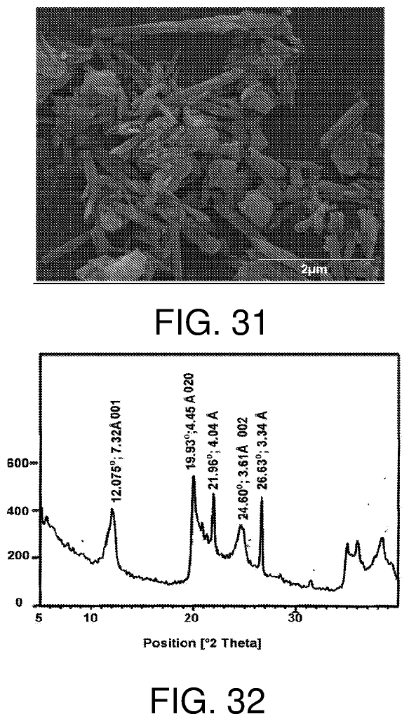

SEM micrograph of as received HNT powders was analyzed as shown in FIG. 31 HNT was found to have predominant rod like structure. The length of HNT clay varied from 200 nm-2 μm and diameter was observed to lie between 100 to 200 nm. Additionally, large particles and small aggregated particles were also present in the HNT nanoclay.

As received HNT clay powder was characterized using wide angle x-ray diffraction. FIG. 32 shows the Wide angle X-ray diffraction (WAXD) spectra of halloysite nanotubes. As reported in literature, the basal space reflections indicate a sharp peak at 12.0° corresponding to a d₀₀₁ basal spacing of 0.73 nm confirmed the multiwall nanotubular structures of halloysite and dehydrated form of halloysite nanoclay. The basal reflections are broad which is attributed to the small crystal size, the inconsistent layer spacing and the curvature of the layers. In addition, the diffraction pattern of neat HNT exhibits other peaks at a 20 of 19.93° and 24.60° respectively, which are related to (020) and (002) basal reflection.

The dehydrated state was also confirmed with the presence of the (002) basal reflection at 2θ of 24.6° which is equivalent to d=0.362 nm. There are two other peaks at 2θ of 21.97° and 26.6°, which indicate the presence of silica, in the forms of cristobalite and quartz, respectively.

### Morphology and Structure of Nanocomposite Filaments

### SEM Analysis

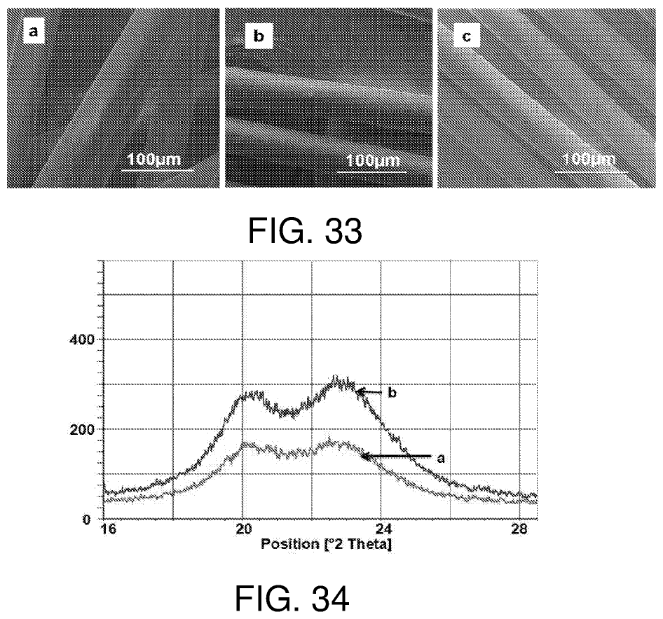

Surface morphology of pure nylon 6 and nanocomposite filaments was analyzed using SEM as shown in FIG. 33a-c. SEM micrographs revealed that 0.5 HNT/Nylon 6, 1.21 HNT/Si-Nylon 6 nanocomposite filaments had smooth surface at low HNT incorporation.

### Wide Angle X-Ray Diffraction Analysis

FIG. 34 shows wide angle x-ray of pure nylon 6 and 1.21 HNT/Si-Nylon 6 nanocomposite filaments. The presence of α crystal peaks at 20.5° and 22.8° confirmed proper drawing. Absence of HNT peak in the composite filaments indicates that HNT nanotubes were properly exfoliated inside the nylon 6 matrix.

### Small Angle X-Ray Scattering (SAXS) Analysis

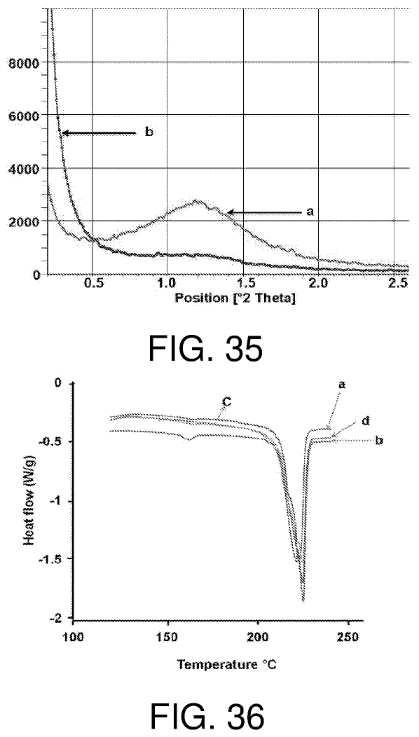

To determine the long range order of crystalline and amorphous region in pure nylon 6 filament and HNT incorporated nylon 6 filaments SAXS analysis was performed. FIG. 35 shows scattered intensity as a function of scattering angle of pure nylon 6 and 1.21 HNT/Si-Nylon 6 drawn filaments. In case of pure nylon 6 peak at 1.2° confirmed long range order. The scattering curve as well as pair distribution function confirmed the lamellar structure of nylon 6. The width of lamella was found to be 2.5 nm and long range ordering of crystalline and amorphous region was 6 nm. It was observed that lamellar structure got diminished on incorporation of HNT in 1.21 HNT/Si-Nylon 6 filaments which may be attributed to exfoliation of HNT inside nylon fibers.

### Thermal Behavior of Nanocomposite Filaments

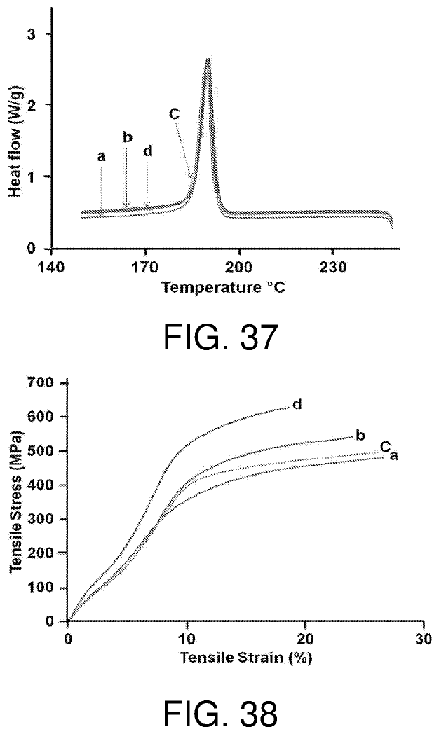

Melting and crystallization behavior of neat nylon 6 and nanocomposite filaments are shown in FIG. 36 and FIG. 37 respectively. All HNT/Nylon 6 nanocomposite filaments had melting peak at 224° C. whereas neat nylon 6 had melting peak at 221° C. Crystallization peak of nanocomposite filaments as well as neat nylon 6 filaments was 189° C. HNT incorporation was not affecting crystallization behavior of nylon 6.

### Mechanical Behavior of Composite Filaments

### Tensile Testing of Composite Filaments

Tensile behavior of pure nylon 6 and HNT loaded nanocomposite filaments is shown in FIG. 38. Table 7 lists the typical values for tensile stress, tensile strain and modulus of Nylon 6, 0.5 HNT/Nylon 6, 0.9 HNT/Nylon 6, Si-Nylon 6, 1.21 HNT/Si-Nylon 6 filaments.

TABLE 7
Tensile behavior nylon 6 and HNT/Nylon 6 nanocomposite filaments

| | | % | | | | |
|---|---|---|---|---|---|---|
| | | Gain | | Modulus | | |
| | Tensile | in | Tensile | at 3% | | % Gain |
| | Stress@Break | Tensile | Strain@Break | strain | Modulus | in |
| Sample Code | (MPa) | Stress | (%) | (MPa) | (MPa) | Modulus |
| Nylon 6 | 471 | — | 29 | 3562 | 3753 | — |
| 0.5HNT/Nylon | 540 | 14.6 | 24 | 3398 | 4838 | 28.9 |
| 6 | | | | | | |
| 0.9HNT/Nylon | 515 | 9.3 | 28 | 3365 | 4438 | 18.3 |
| 6 | | | | | | |
| Si-Nylon 6 | 437 | — | 34 | 1624 | 3304 | — |
| 1.21HNT/Si- | 626 | 43.2 | 18 | 4621 | 6272 | 89.8 |
| Nylon 6 | | | | | | |

It was found that tensile stress and modulus of 0.5 HNT/Nylon 6 composite filaments was improved 1400 and 29% respectively compared to pure nylon 6 filaments. In 0.9 HNT/Nylon 6 filaments improvement of tensile stress and modulus was lower as compared to 0.5 HNT/Nylon 6 which may be attributed to the agglomeration of clay particles on higher loading. Tensile stress and modulus of pure nylon 6 filaments was found to be 471 MPa and 3753 MPa respectively. On the other hand, tensile stress and modulus of Si-Nylon 6 filaments were 437 MPa and 3304 MPa. Addition of silicon oil resulted in marginal decrease in tensile stress and modulus of pure nylon 6 filaments as it works as plasticizer. However, silicone oil enabled dispersion of HNT in 1.2 HNT/Nylon 6 composite filaments which resulted in significant improvement of 43% and 90% in tensile stress and modulus.

### Creep Testing of Nanocomposite Filaments

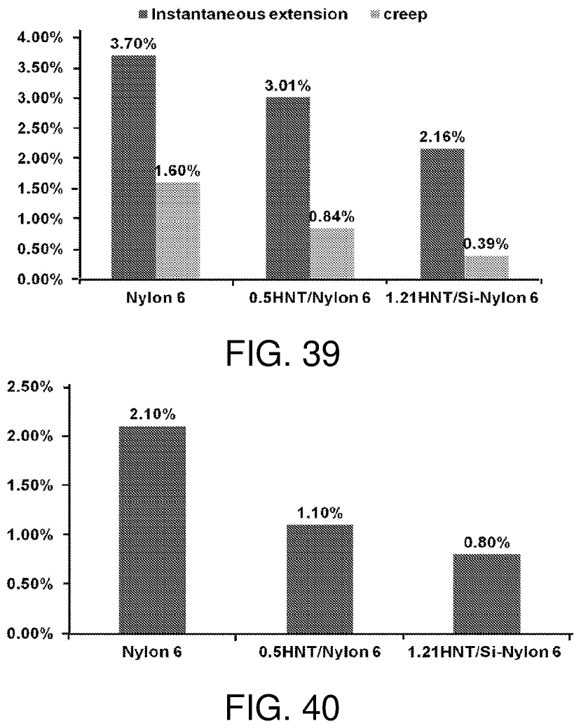

Creep test of HNT loaded nylon 6 nanocomposite filaments was carried out to understand time dependent deformation behavior of filament as compared to pure nylon 6 filaments. It was observed from FIG. 39 that on loading instantaneous extension and creep of control nylon 6 filaments was 3.7% and 1.6% respectively. After load removal the secondary creep was 2.05% as presented in FIG. 40. HNT loaded filaments with or without silicone oil however resulted in instantaneous extension and creep was low in case of both loading and load removal. 0.5 HNT/Nylon 6 filaments exhibit 3.01% and 0.84% instantaneous extension and creep respectively on loading where as 1.1% secondary creep after load removal. In case of 1.21 HNT/Si-Nylon 6 filaments instantaneous extension and creep were observed to be 2.16% and 0.39% respectively on loading where as 0.80% was secondary creep percentage after load removal. This indicates that addition of HNT imparts rigidity to the nylon 6 polymer and therefore reduces the creep tendency of nylon 6 filaments.

### Example 3

### Preparation of ZnO Nanowires Reinforced Polypropylene Composite Fibers

Commercial textile grade H350FG isotactic polypropylene granules having MFI (melt flow index) of 33 g/10 min at 230° C., were supplied by Reliance industries limited. For synthesis of ZnO nanowires the following chemicals were used: ZnCl₂ as a precursor from Merck, India having pure anhydrous grade with molecular weight 136 with 99.9% purity in the powder form. Sodium carbonate (Na₂CO₃) from Merck, India as a nucleating agent to control crystal growth. Sodium dodecyl Sulphate (SDS), (CH₃ (CH₂)₁₁OSO₃Na) purchased from Merck, India as a kinetic controller.

### Preparation of ZnO Nanowires

The ZnO nanowires were synthesized by low temperature one pot hydrothermal route [Hu, et al., Materials Chemistry and Physics 2007, 106, 58-62]. In a typical method 0.8 gm. zinc chloride & 5 gm. SDS were mixed with 30 ml of water, & transferred to teflon sleeve. Then, 27 gm. sodium carbonate was added to this & this mixture was thoroughly mixed with help of magnetic stirrer with addition of small amount of water. The total volume in the reactor should not be more than 80% of total volume & this was kept in oven at 160° C. for 14 h. The reaction product was washed several times with hot water and centrifuged at 10,000 rpm for 2 min to remove the SDS completely. After, thorough washing, the product was dried in oven at 105° C. to remove the moisture completely. The prepared nanowires were hydrophilic in nature.

### Surface Modification of ZnO Nanowires

The nanowires like to agglomerate in the polymer matrix because of high surface energy. So, to keep separate nanowires for homogeneous dispersion in polymer matrix, the nanowires were made hydrophobic. The nanowires were prepared by hydrothermal synthesis by same method mentioned above. Then the lauric acid was used to modify the surface of nanowires (for making them hydrophobic). First, the nanowires were dispersed in acetone with the help of ultrasonication. Then the calculated amount of lauric acid (0.05 & 0.1 owf ZnOw) was added in dispersed nanowires at room temperature and the mixture was kept standing for 2 h. The hydrophobicity was checked by measuring water contact angle.

### Melt Compounding (Master Batch Preparation)

Surface modified ZnO nanowires & polypropylene was melt compounded in twin screw extruder (Thermo Fisher Scientific, India). Twin screw extruder is a machine for melt compounding of polymer chips with other materials to produce small batches. At high temperature the molten PP mixes due to the mechanical energy provided by rotating screws. The required quantity of materials was taken to produce master batches containing 0.3 wt % of ZnO nanowires. In a typical procedure, the ZnO nanowires were dispersed in acetone by ultrasonication. Polypropylene chips were mixed properly in this acetone. The polymer chips get coated by dispersed nanowires. The 0.3 wt % hydrophilic & hydrophobic master batches were prepared. To remove the acetone, the master batches were kept in oven under active vacuum at 105° C. for 2 hours. After that the material was dried in active vacuum continued for at least one day. The temperature profile of melt compounding 220/220/225/230/235/240/240 was maintained. The extruder speed was 100 rpm in TSE. The pure polypropylene chips were also extruded through TSE to prepare a control sample with the same thermo-mechanical history.

Sample codes: The composite master batches and the composite fibres produced were coded on the basis of amount of ZnO nanowires used. For as spun filaments AS and additional letter FD for the drawn samples was used in front of the code. The codes of various samples produced: These samples were coded as these samples were coded as PP-ZnOw0.3 hyl, PP-ZnOw0.3 hylAS PP-ZnOw0.3 hylFD & PP-ZnOw0.3 hyb, PP-ZnOw0.3 hybAS, PP-ZnOw0.3 hybFD. The extruded strands were pelletized prior to melt spinning process.

### Melt Spinning & Drawing of Master Batch

Melt spinning of pure PP & PP—ZnO nanocomposite batches was carried out in Hills spinning machine (Model LBS Lab Bicomponent Extrusion Machine, Hills). This machine consists of a melting device an extruder, a manifold distribution arrangement for the melt, Metering pump to control the flow rate of polymer, spin pack assembly to filter & extrude the polymer through fine holes, room temperature cooling & a winder to pull & wind the extruded filament. The extruder zone includes one hopper, one feed zone, & two heating zone. Monofilaments of polypropylene & PP-nanocomposite of all the three batches were spun as per the spinning parameters detailed below. Extruder temperature were (zone 1) 220° C. & (zone 2) 230° C., metering temperature 240° C., spin head temperature 240° C., metering pump speed 2 rpm, take-up speed 100 mpm. The melt spun samples were drawn at draw ratio 10.

### Characterization of ZnO Nanowires

The surface morphology of ZnO nanostructures were characterized using Scanning electron microscope (Quanta200 FEG). A small amount of ZnO nanostructures dispersion was put on the cover slip. The length & diameter of nanostructure was measured. The water contact angle of surface modified ZnO nanowires was measured by circle fit method.

### Hot Stage Melts Study

The dispersion of nanowires in polymer and its crystallization behavior of melt compounded samples were studied using the hot stage platform integrated with optical light polarizing microscope. The dispersion of nanowires in melt PP was seen under microscope with 20× magnification. For this study the control PP & nanocomposite master batch PP were melted at 200° C. and held for 1 min for uniform melting. Then the temperature was lowered at a rate of 10° C./min up to 130° C. and then the crystallization of these samples were observed.

### Thermal Stability

The TGA of the melt spun filament was performed in Thermo gravimetric analyzer by TA instrument (Model no. Q500) from 20° C. to 600° C. at a heating rate of 20° C./min in nitrogen atmosphere to determine the stability of polymer over the range of temperature.

### DSC Analysis

Differential scanning calorimetry (DSC) measurement was carried out using DSC 200 (TA instrument, New Castle, Del., USA) to examine the thermal behavior of pure PP chips. Samples of 5-10 mg were cut & equilibrated from 20° C. to 200° C. at 10° C./min, kept at isothermal conditions for 1 min & then cooled to room temperature at same rate under nitrogen atmosphere at a flow rate 50 ml/min.

### Birefringence

The orientation of the polymer chains along & across the fiber axis was studied using optical light polarizing microscope. The filaments were kept in taut condition on glass slide & a drop of paraffin oil was dropped on the filament. The plane polarized light has path difference when impinged on the samples due to the difference in refractive index. So, compensator is used to compensate these path differences. The path difference was measured along & across the fiber axis and the orientation was calculated by considering fiber diameter.

### Mechanical Properties

The tensile strength, initial modulus, elongation at break of the drawn filaments of neat PP & composites with nanowires were studied by Instron tensile tester (Instron 4301 & Instron micro tester) with load cell 10N & gauge length of 25 mm at a speed of 300 mm/min. Mean values are averages of 15 measurement of each sample. For each measurement sample diameter was taken using optical microscope.

### UV Stability

PP can be easily degraded under the UV radiation because of tertiary carbon atom present in chemical structure of PP can be easily breakdown from the main chain structure of polymer chains. The main aim of this study was to determine the stability of PP nanocomposite filaments under UV radiation by accessing change in its mechanical properties comparing before & after UV exposure. The drawn samples of the nanocomposites & control PP were exposed under UV light for 24 h, 48 h & 5 days by samples in UV chamber. The distance of 30 cm was maintained between UV light source & the exposed samples. The mechanical properties were determined at regular intervals to understand the role on incorporated nanostructures.

### Thermal Shrinkage Study

The thermal shrinkage study was carried out to observe the fiber behavior under thermal energy. The change in fiber length due to thermal energy shows the thermal stability of fiber in thermal environment. The samples of nanocomposite filaments along with control PP in as spun & drawn stage were taken for this study. The hot air & boiling water shrinkage of these samples were carried out at 105° C. for 30 min.

### Creep Study

Creep is the time dependent extension at constant load. The aim of this study was to see the fiber behavior in stretch condition at constant load. The stability of the samples under constant load was checked. The samples of nanocomposite filaments with control PP of as spun & drawn were loaded at 5% & 10% loads of breaking strength of the filaments. The time dependent extensions of these samples were measured.

### Characterization of ZnO Nanowires

The high aspect ratio ZnO wires were synthesized using zinc chloride as precursor and Na₂CO₃ as oxidizing agent. The Na₂CO₃ concentration controls the nucleation process; SDS act as template for growth of high aspect ratio nanostructures and hence tunes the aspect ratio The synthesis of nanowires was carried out as per the procedure discussed above. The structure & morphology of these nanostructure was developed through chemical reaction detailed below.

CO₃²⁻+H₂O→HCO₃-+OH⁻ (1)

HCO₃-+H₂O→H₂CO₃+OH⁻ (2)

Zn²⁺+4OH⁻→Zn(OH)₄ (3)

Zn(OH)₄²_→ZnO+H₂O+2OH⁻ (4)

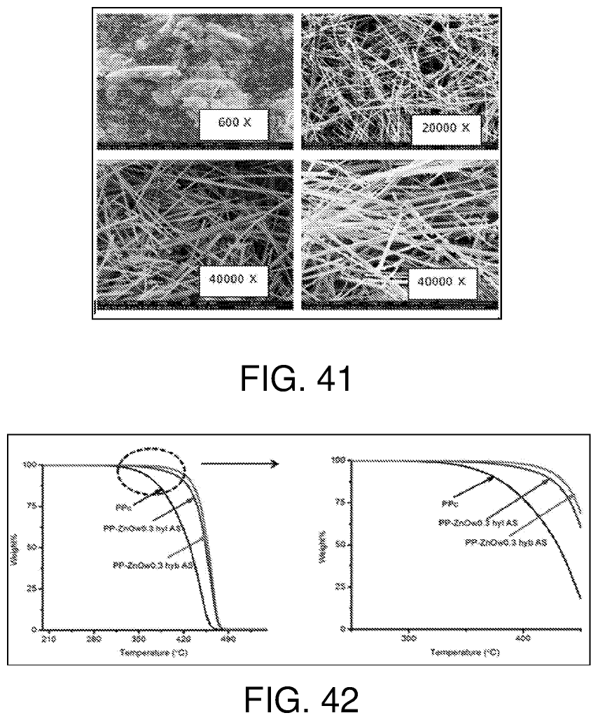

The synthesis process involves nucleation and growth steps [reaction 3& 4]. The control of precursor to sodium carbonate ratio controls the aspect ratio of nanowires. At a very high concentration of Na₂CO₃, the excessively produced Zn(OH)₄²⁻ precursor is present in a supersaturated concentration which favors the homogeneous nucleation process resulting into formation of much smaller nuclei. The larger number of nuclei could further grow in high aspect ratio nanostructures. From SEM images, it was observed that nanowires had the avg. diameter of 55 nm and avg. length was 12 μm. The aspect ratio was determined to be ˜218. The formulated by trial & error recipe for synthesis of nanowires was selected and several batches were prepared to synthesize large amount of ZnO wires required for melt spinning trials. The SEM images of these synthesized nanowires at different magnification and washing are shown in FIG. 41.

### Characterization of Surface Modified Zno Nanowires

The ZnO nanowires are hydrophilic in nature therefore may pose a difficulty while blending with hydrophobic polypropylene. To enhance the interaction of ZnO nanowires with polymers and to obtain well dispersed ZnO nanowires/PP composite, the surface of nanowires was modified using lauric acid.

The hydrophilic head groups of lauric acid are expected to align towards the surface of ZnO and hydrophobic carbon chain away from it. This procedure resulted in successful modification of surface of these nanostructures. This was confirmed by measuring the water contact angle on these nanostructures.

For measurement of water contact angle the 10 μL tip was used. The water contact angle was measured by circle fit method. The water contact angles were 1300 & 150° for 0.1 & 0.05 LA owf ZnO nanowires respectively. The control sample had no hydrophobicity. The water was absorbed instantaneously by nanowires which confirm the hydrophilic nature of ZnO nanowires. It shows that LA was helping for modifying the surface and making it hydrophobic. In some cases it was observed that the water drop rolled down (in case of (0.05 LA ZnOw hyb). That means for achieving hydrophobicity the amount of LA requirement was very low to avoid masking effect.

### Characterization of Master Batch

### Hot Stage Melt Study

The dispersion of ZnO nanowires in the PP matrix was studied before melt spinning using hot stage microscope (hot stage integrated with optical light microscope). After confirmation homogeneous dispersion of the nanowires in polymer matrix, the melt compounded samples were palletized & taken for melt spinning.

### Characterizations of Melt Spun & Drawn 0.3 wt % Master Batch Fibers

Melt spinning of pure PP & nanowires loaded PP melt compounded nanocomposite batches was accomplished smoothly on Hills spinning machine. Continuous spinning without breakages was possible. The 0.3 master batch samples were spun at metering pump speed 1.8 rpm with mass flow 0.584 cc/rev & take up speed 100 mpm. The as spun samples were drawn at draw ratio 10 & draw ability of the samples was observed to be good. The actual denier of filament was 85.

### Thermal Stability

The thermo gravimetric traces of melt spun as spun filament, prepared by adding 0.3 wt % ZnO nanowires compared to control processed PP was recorded in nitrogen atmosphere Thermal stability of nanocomposite filaments was evaluated in the filaments to determine the percentage of nanowires present. From FIG. 42, it was observed that TGA graphs of PP-ZnOw0.3 hyl & PP-ZnOw hyb nanocomposite filaments were marginally shifted towards higher temperature compare to control PP. This may be due to delay in response by nanocomposite filaments molecular chains to temperature because of homogeneous dispersion of nanowires in filaments. Enhancement in thermal stability of PP-ZnOw0.3 hyb compared to other samples may be due to homogeneous dispersion of hydrophobic nanowires than hydrophilic nanowires.

TABLE 8
TGA results of 0.3 wt % master batch as spun filaments

| | Onset | Max.deg. | Endset | Residue |
|---|---|---|---|---|
| Samples | Temp (° C.) | Temp.(° C.) | Temp.(° C.) | (Wt %) |
| PPc | 316 | 446 | 471 | 0.2823 |
| PP-ZnO 0.3 | 358 | 462 | 485 | 0.4332 |
| hyl | | | | |
| PP-ZnO 0.3 | 386 | 464 | 486 | 0.4386 |
| hyb | | | | |

### DSC Analysis

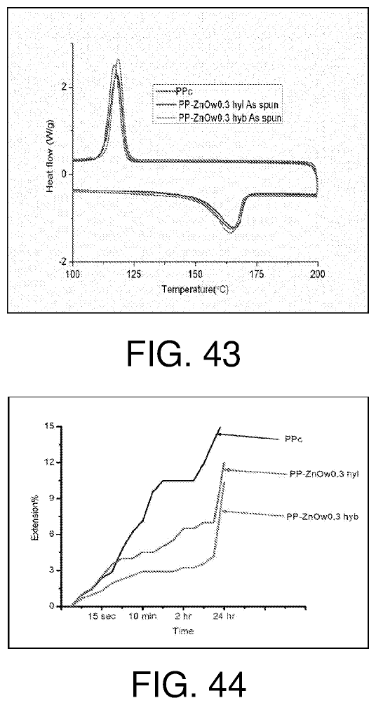

The incorporation of nanomaterial in polymer matrix is expected to influence the crystallization behavior of the polymer; this was investigated by differential scanning calorimetric studies. From FIG. 43, it was seen no significant difference seen in melting behavior of above samples during heating cycle. The melting temperature was ˜165° C. In cooling cycle, the crystalline peak was observed at slightly higher temperature compared to control PP.

### Birefringence Study

Birefringence of the drawn filaments was measured to ascertain the orientation of polymer chains in the fibers. This study was performed using optical light polarizing microscope.

### Orientation was Calculated by the Equation

$$Birefringence Δ n = \frac{6.18 \times Phase difference in nm}{1000 \times Diameter of filament in μm}$$

TABLE 9
Birefrigence of PP fibres

| | Birefringence value | | |
|---|---|---|---|
| Samples | PPc | PP-ZnOw0.3 hyl | PP-ZnOw0.3 hyb |
| AS spun fiber | 0.00936 | 0.00879 | 0.0108 |
| Drawn fiber | 0.0428 | 0.0530 | 0.0673 |

From, above Table 9 it was seen that, the orientation of the as spun filaments & drawn filaments of nanocomposite samples were more than control PP. It may be due to presence of nanowires helping polymer chains in orienting along the filament axis. The PP—ZnO w0.3 hyb sample filament shows higher orientation in both as spun & drawn state, may be because of homogeneous dispersion of nanowires in polymer helping polymer chains in orientation phenomenon.

### Mechanical Properties

### Mechanical Properties of Drawn Fibers

To resolve the issue of aggregation of nanowires in polymer matrix, the nanowires were modified to change the surface characteristics similar to polymer matrix. The tensile properties of 0.3 wt % ZnO PP composite fibres are summarized in Table 10. From, the table it is seen that, the breaking stress increases by ˜0.16 & 46% in case of PP-ZnOw0.3 hyl & PP-ZnOw0.3 hyb, respectively, compared to control PP. The modulus value was also observed to increase by 42 & 86% in nanocomposite samples compare to control PP. It means that nanowires in PP polymer matrix were helping to share the load along with polymer chains during tensile loading.

TABLE 10
Mechanical properties of 0.3 wt % master batch drawn filaments

| Samples/parameters | PPc | PP-ZnOw0.3 hyl | PP-ZnOw0.3 hyb |
|---|---|---|---|
| Breaking stress(Mpa) | 584 ± 44 | 675 ± 45 | 855 ± 40 |
| Breaking strain (%) | 30 | 38 | 25 |
| Modulus(Mpa) | 2826 | 4020 | 5287 |

### Mechanical Properties of UV Exposed Drawn Filaments

The ZnO nanostructure exhibit absorption in UV region and are expected to improve the UV stability of composite fibres. Therefore, the UV stability of nanocomposite samples along with control PP was accessed by measuring mechanical properties of these drawn samples after UV exposure of 24, 48 hours & 5 days.

TABLE 11
Mechanical properties of UV exposed 0.3 wt % master batch drawn fibers

| | | Breaking | | |
|---|---|---|---|---|
| | Breaking Stress | Strain | Modulus | |
| Sample | (Mpa) | (%) | (Mpa) | Remarks |
| Control PP | | | | 25% |
| Without exposure | 584 ± 44 | 30 | 2826 | decrease in |
| 24 h exposure | 566 ± 38 | 26 | 2982 | breaking |
| 48 h exposure | 526 ± 44 | 28 | 2551 | stress after 5 |
| 5 days exposure | 468 ± 62 | 20 | 2551 | days |
| PP-ZnOw0.3 hyl | | | | 37% |
| Without exposure | 675 ± 45 | 38 | 4020 | days |
| 24 h exposure | 605 ± 29 | 29 | 3562 | decrease in |
| 48 h exposure | 592 ± 37 | 26 | 2747 | breaking |
| 5 days exposure | 493 ± 44 | 25 | 2442 | stress after 5 |
| PP-ZnOw0.3 hyb | | | | 22% |
| Without exposure | 855 ± 40 | 25 | 5287 | days |
| 24 h exposure | 786 ± 63 | 29 | 4161 | decrease in |
| 48 h exposure | 733 ± 45 | 26 | 3786 | breaking |
| 5 days exposure | 702 ± 29 | 25 | 3685 | stress after 5 |

From, the table it was seen that the neat or control PP underwent more severe drop in properties compared to composite fibres. ZnO nanowires with hydrophobic surface were observed to exhibit less reduction in tensile properties compared to ZnO nanowires which are inherently hydrophilic. There was no significant difference in breaking strain after UV exposure. The modulus has been loosed in all samples. The UV stability was not improved significantly but it was may be due to presence of nanowires helping in UV stability. The proposed mechanism of UV stability due to nanowires that, during UV irradiation on samples, some part of UV energy may be absorbed by nanowires & did not transfer to the polymer chains. So, the UV energy requires for the initiation mechanism for withdrawing tertiary carbon atom from polymer chain was more & thus the UV stability increases in nanocomposite compare to control PP.

### Shrinkage Study

Shrinkage is the change in dimensions of material due to thermal energy. The dimensionally unstable material under thermal energy shows the shrinkage behavior. Thermal stability of PP nanocomposites samples were tested at 105° C. for 30 min. It was seen no significant difference in shrinkage % of as spun & drawn filaments in both type of shrinkage study that is hot air shrinkage & boiling water shrinkage.

### Creep Study

The dimensional stability of material can be checked under constant load. The drawn filaments of above batches were loaded at 10% of breaking stress & the time dependent extension was checked. From, FIG., it was observe that, in case of as spun filaments the time dependent extension at constant load was high compared to drawn filaments. In as spun & drawn filaments also the control PP had shown more % extension than nano composite filaments.

From FIG. 44, it was observed that the hydrophobic master batch showing less creep behavior than other two batches. There was 23% & 34% decrease in creep behavior in 0.3 wt % hydrophilic & hydrophobic master batch compare to control PP. It may be due to presence of nanowires in polymer which restrict the unfolding of polymer chains at constant load. The high aspect ratio surface modified hydrophobic ZnO nanowires with water contact angle 155° were successfully synthesized. These nanowires were characterized, blended with polypropylene polymer & melt spun. The mechanical properties, thermal and UV stability and the structure of composite fibers in comparison to control PP were investigated. The nanocomposite master batch of 0.3 wt % ZnO hydrophobic nanowires shown increase in thermal stability compared to control PP sample. It was also observed that, increase in orientation of nanocomposite filaments in both as spun & drawn condition compare to control PP. It was observed that increase in breaking stress & modulus by 46 & 86% respectively compared to control PP. This may be due to alignment of nanowires along with fiber axis, helping in sharing load with polymer chains. It was also observed that the creep behavior of nanocomposite better than control sample in drawn condition. The thermal shrinkage had no significant difference in all three samples.

### Advantages of Invention

The composite of the present disclosure are mechanically strong fibres with high extension rate, high impact strength with multiple functionalities. Depending on the material of wires, the fibers can be used for inherent UV protection, IR reflection, electrical conduction, radar and sensing applications, antimicrobial, piezoelectric effect, etc. The composite of the present disclosure can also be used like in technical/industrial materials such as belts, tyres, ropes, soft armours, flexible tubes/hoses, flexible conducting wires, and structural fibres for tents, canopies, stadium roofs.

Although the subject matter has been described in considerable detail with reference to certain preferred embodiments thereof, other embodiments are possible. As such, the spirit and scope of the appended claims should not be limited to the description of the preferred embodiment contained therein.

I/We claim:

1. A composite fiber comprising an array of inorganic nanowires embedded in a polymer matrix, wherein:
the nanowires have a diameter <100 nm and high aspect ratio of at least 5 with homogenous dispersion and polymer chains of the polymer matrix and the nanowires are oriented along a fiber axis,
a nanowire wt % in the composite fiber is in a range of 0.01 to 2 wt %, and
the inorganic nanowires are non conducting and include at least one of ZnO, or aluminosilicate clay tubes.

2. The composite fiber as claimed in claim 1, wherein the polymer is selected from the group consisting of polyesters, polyethylene, polypropylene, poly aromatic amides, polyether ether ketone (PEEK), polybutylene terephthalate (PBT), poly(p-phenylene benzobisoxazole (PBO), polyacrylonitrile, polyamides, polyimide, polyurethanes, conducting polymers, polytetrafluroethane, polyvinylenedifluoride (PVDF), polyimides, cellulose acetate, and combination thereof.

3. The composite fiber as claimed in claim 1, wherein the polymer is nylon 6 or polypropylene (PP).

4. The composite fiber as claimed in claim 1, wherein the inorganic nanowire is ZnO or aluminosilicate clay tubes.

5. The composite fiber as claimed in claim 1, wherein the nanowires have an aspect ratio in a range of 10 to 500.

6. The composite fiber as claimed in claim 1, wherein the inorganic nanowires are selected from a group consisting of ZnO, and aluminosilicate clay tubes.

7. The composite fiber as claimed in claim 1, wherein the inorganic nanowires are with or without surface modification.

8. A process for preparation of a composite fiber comprising an array of inorganic nanowires embedded in a polymer matrix, wherein:
the nanowires have diameter of <100 nm and a high aspect ratio of at least 5 with homogenous dispersion and polymer chains of the polymer matrix and the nanowires are oriented along a fiber axis,
a nanowire wt % in the composite fiber is in a range of 0.01 to 2 wt %, and
the inorganic nanowires are non conducting and include at least one of ZnO, or aluminosilicate clay tubes
the process comprises:
contacting nanowires having diameter <100 nm and aspect ratio of at least 5 with a polymer to obtain a mixture comprising nanowires and polymer; and
subjecting the mixture through melt or solution homogenization to obtain uniform distribution and homogenous dispersion of nanowires in polymer matrix;
and subjecting the nanowires in polymer matrix to melt spinning or solution spinning followed by drawing and heat-setting to obtain composite fiber comprising an array of nanowires having diameter <100 nm and aspect ratio of at least 5 oriented along the fiber axis embedded in an oriented polymer matrix.

9. The process as claimed in claim 8, wherein the polymer is selected from the group consisting of polyesters, polyethylene, polypropylene, poly aromatic amides, polyether ether ketone (PEEK), polybutylene terephthalate (PBT), poly(p-phenylene benzobisoxazole (PBO), polyacrylonitrile, polyamides, polyimide, polyurethanes, conducting polymers, polytetrafluroethane, polyvinylenedifluoride (PVDF), polyimides, cellulose acetate, and combination thereof.

10. The process as claimed in claim 8, wherein the polymer is nylon 6, or polypropylene (PP).

11. The process as claimed in claim 8, wherein the nanowires have an aspect ratio in a range of 10 to 500.

12. The process as claimed in claim 8, wherein the inorganic nanowires are ZnO or aluminosilicate clay tubes.

13. The process as claimed in claim 8, wherein the polymer is in a form of granules or a solution form.

14. The process as claimed in claim 8, wherein the inorganic nanowires are in a form of powder or a liquid dispersion.

15. The process as claimed in claim 8, wherein the inorganic nanowires are with or without surface modification.
